(19) United States
(12) Patent Application Publication
(10) Pub. No.: US 2026/0357709 A1
(43) Pub. Date: Nov. 12, 2026

(54) BLADE RING ASSEMBLY AND GAS TURBINE PROVIDED WITH SAME

(71) Applicant: MITSUBISHI HEAVY INDUSTRIES, LTD., Tokyo (JP)

(72) Inventors: Shin KATO, Tokyo (JP); Kazuharu HIROKAWA, Tokyo (JP); Kota FUJIHARA, Tokyo (JP); Naoki TAKETA, Tokyo (JP); Atsuhide INATOMI, Tokyo (JP); Akihiro MATSUNOSHITA, Tokyo (JP); Ikko TSUBOKURA, Tokyo (JP); Shinya HASHIMOTO, Tokyo (JP)

(21) Appl. No.: 19/119,521

(22) PCT Filed: Oct. 12, 2023
(86) PCT No.: PCT/JP2023/037075

§ 371 Date: Apr. 9, 2025

(30) Foreign Application Priority Data
Oct. 14, 2022 (JP) 2022-165186

(51) Int. Cl. F01D 9/04; F01D 25/12

(52) U.S. Cl. CPC F01D 9/041; F01D 25/12; F05D 2240/35; F05D 2240/55; F05D 2260/30

(57) ABSTRACT

A blade ring assembly includes a turbine blade ring extending in a circumferential direction about an axis, a stator vane on an inner peripheral side of the turbine blade ring, and a deflector on an outer peripheral side of at least a part of the turbine blade ring. The turbine blade ring includes a blade ring main body, and a plurality of protruding portions protruding from the blade ring main body toward both axial upstream sides, and disposed at different positions in the circumferential direction at intervals from each other. Two adjacent protruding portions form a cooling medium intake port allowing communication from the outer peripheral side to the inner peripheral side of the turbine blade ring, and the deflector shields at least a part of the cooling medium intake port when viewed in a radial direction about the axis.

### TECHNICAL FIELD

The present disclosure relates to a blade ring assembly and a gas turbine provided with the same.

Priority is claimed on Japanese Patent Application No. 2022-165186, filed on Oct. 14, 2022, the content of which is incorporated herein by reference.

### BACKGROUND ART

Patent Document 1 discloses a gas turbine provided with a mechanism for separating particles included in cooling air. This gas turbine includes a protective element for particle separation that is disposed on an inner peripheral side (rotor side) with respect to a stator vane, and the protective element for particle separation makes it difficult for floating particles to flow in an intake opening.

### CITATION LIST

### Patent Document

Patent Document 1: Published Japanese Translation No. 2010-501764 of the PCT International Publication

### SUMMARY OF INVENTION

### Technical Problem

However, the protective element for particle separation described in Patent Document 1 does not prevent the cooling air supplied from a compressor into a casing from flowing into an air passage communicating with the inside of the stator vane as it is. Therefore, the cooling air including a foreign matter may flow into the inside of the stator vane, and clogging may occur in a cooling passage inside the stator vane.

The present disclosure has been made in order to solve the above-described problems, and an object of the present disclosure is to provide a blade ring assembly capable of preventing a foreign matter from flowing into a stator vane, and a gas turbine provided with the same.

### Solution to Problem

In order to solve the aforementioned problem, according to the present disclosure, there is provided a blade ring assembly including a turbine blade ring that extending in a circumferential direction about an axis, a stator vane is disposed on an inner peripheral side with respect to the turbine blade ring, and a deflector is disposed on an outer peripheral side with respect to at least a part of the turbine blade ring, in which the turbine blade ring includes a blade ring main body, and a plurality of protruding portions that protruding from the blade ring main body toward an axial upstream side of both sides in an axial direction where the axis extends, and that is disposed at different positions in the circumferential direction at intervals from each other, two protruding portions included in the plurality of protruding portions and adjacent to each other in the circumferential direction, two protruding portions form a cooling medium intake port which communicated from the outer peripheral side to the inner peripheral side of the turbine blade ring, together with the blade ring main body, and the deflector is disposed to shield at least a part of the cooling medium intake port in a case of being viewed in a radial direction about the axis.

In order to solve the aforementioned problem, according to the present disclosure, there is provided a gas turbine including a rotor configured to rotate about the axis, a casing that covers the rotor from an outer peripheral side, the blade ring assembly configured to cover the rotor from the outer peripheral side in a state of being supported by the casing, and a combustor configured to generate combustion gas by combustion of fuel and send the combustion gas into the casing, in which the stator vane included in the blade ring assembly is a first stage turbine stator vane in the axial direction.

### Advantageous Effects of Invention

The blade ring assembly of the present disclosure and the gas turbine provided with the blade ring assembly can prevent a foreign matter from flowing into the stator vane.

### BRIEF DESCRIPTION OF DRAWINGS

FIG. 1 A cross-sectional view schematically representing an entire gas turbine according to a first embodiment of the present disclosure.

FIG. 2 An enlarged cross-sectional view representing a part of a gas turbine according to the first embodiment of the present disclosure.

FIG. 3 A cross-sectional view schematically representing a part of a blade ring assembly according to the first embodiment of the present disclosure.

FIG. 4 A perspective view representing a part of the blade ring assembly according to the first embodiment of the present disclosure in an exploded manner.

FIG. 5 A cross-sectional view taken along line V-V of the blade ring assembly shown in FIG. 3.

FIG. 6 A plan view representing a deflector according to the first embodiment of the present disclosure.

FIG. 7 A front view representing the deflector according to the first embodiment of the present disclosure.

FIG. 8 A cross-sectional view representing a shielding cover according to the first embodiment of the present disclosure.

FIG. 9 A cross-sectional view representing an action of the deflector according to the first embodiment of the present disclosure.

FIG. 10 A perspective view representing a part of a blade ring assembly according to a second embodiment of the present disclosure.

FIG. 11 A plan view representing a deflector according to the second embodiment of the present disclosure.

FIG. 12 A cross-sectional view representing an action of the deflector according to the second embodiment of the present disclosure.

FIG. 13 A perspective view representing a deflector according to another embodiment of the present disclosure.

### DESCRIPTION OF EMBODIMENTS

### First Embodiment

Hereinafter, a blade ring assembly according to a first embodiment of the present disclosure and a gas turbine provided with the blade ring assembly will be described with reference to the drawings. In the following description, the same reference numerals are assigned to configurations having the same or similar functions. Duplicate descriptions of such configurations may be omitted.

### Configuration of Gas Turbine

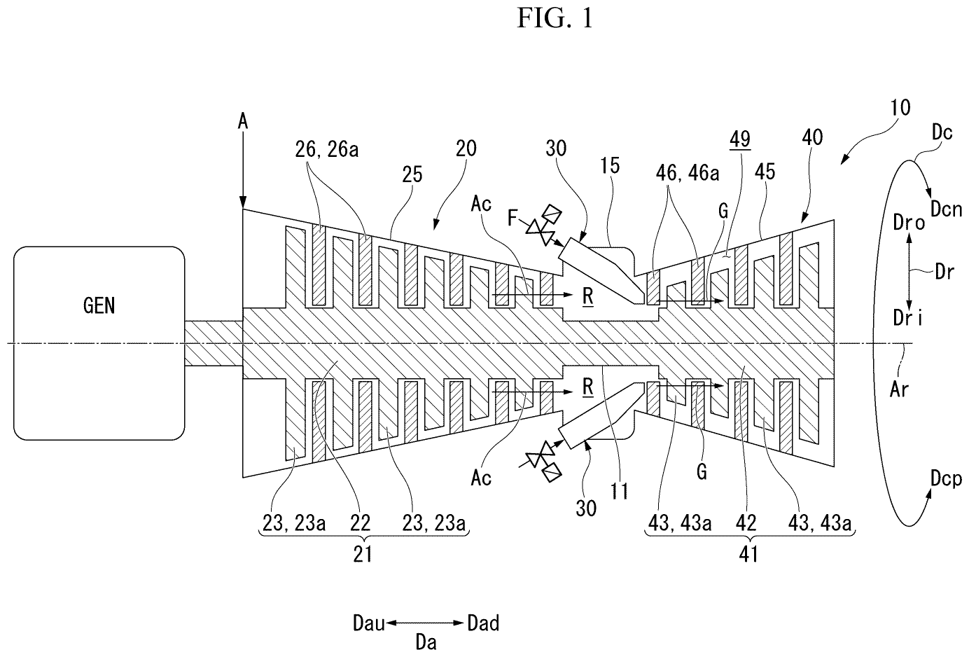

FIG. 1 is a cross-sectional view schematically showing an entire gas turbine 10 in the present embodiment. The gas turbine 10 is provided with a compressor 20 that compresses air A, a combustor 30 that combusts fuel F in the air A compressed by the compressor 20 to generate combustion gas G, and a turbine 40 driven by the combustion gas G.

The compressor 20 includes a compressor rotor 21 that rotates about an axis Ar, a compressor casing 25 that covers an outer peripheral side of the compressor rotor 21, and a plurality of stator vane stages 26. The turbine 40 includes a turbine rotor 41 that rotates about the axis Ar, a turbine casing 45 that covers an outer peripheral side of the turbine rotor 41, and a plurality of stator vane stages 46.

The compressor rotor 21 and the turbine rotor 41 are located on the same axis Ar and are connected to each other to constitute the gas turbine rotor 11. For example, a rotor of a generator GEN is connected to the gas turbine rotor 11. The compressor casing 25 and the turbine casing 45 are connected to each other to constitute a gas turbine casing 15. The gas turbine casing 15 is an example of a “casing”. For example, the combustor 30 is a can-type combustor.

Here, in the following description, a direction where the axis Ar extends is defined as an “axial direction Da”, a circumferential direction about the axis Ar is defined as a “circumferential direction De”, and a direction perpendicular to the axis Ar about the axis Ar is defined as a “radial direction Dr”. Among both sides in the axial direction Da, a side of the compressor 20 with respect to the turbine 40 is defined as an “axial upstream side Dau”, and a side opposite to the compressor 20 is defined as an “axial downstream side Dad”. In addition, among both sides in the radial direction Dr, a side close to the axis Ar is defined as a “radially inner side Dri”, and a side opposite to the axis Ar is defined as a “radially outer side Dro”. In addition, among both sides in the circumferential direction Dc, a side from a positive pressure surface toward a negative pressure surface of a blade body 110 of a stator vane 46a, which will be described later, is defined as a “circumferential direction Den”, and a side from the negative pressure surface toward the positive pressure surface of the blade body 110 is defined as a “circumferential direction Dcp”. The axial direction Da is a flow direction of the combustion gas G.

The compressor rotor 21 includes a rotor shaft 22 that extends in the axial direction Da about the axis Ar and a plurality of rotor blade stages 23 attached to the rotor shaft 22. The plurality of rotor blade stages 23 are arranged at intervals in the axial direction Da. Each of the rotor blade stages 23 includes a plurality of rotor blades 23a arranged in the circumferential direction Dc. The stator vane stage 26 is disposed on each of the axial downstream sides Dad of the plurality of rotor blade stages 23. Each of the stator vane stages 26 is attached to the inside of the compressor casing 25. Each of the stator vane stages 26 includes a plurality of stator vanes 26a arranged in the circumferential direction Dc.

The turbine rotor 41 includes a rotor shaft 42 that extends in the axial direction Da about the axis Ar, and a plurality of rotor blade stages 43 attached to the rotor shaft 42. The plurality of rotor blade stages 43 are arranged in the axial direction Da. Each of the rotor blade stages 43 includes a plurality of rotor blades 43a arranged in the circumferential direction Dc. The stator vane stage 46 is disposed on the axial upstream side Dau of each of the plurality of rotor blade stages 43. Each of the stator vane stages 46 is attached to the inside of the turbine casing 45. Each of the stator vane stages 46 includes a plurality of gas turbine stator vanes 46a arranged in the circumferential direction Dc. In the following, for convenience of description, the gas turbine stator vane 46a will be simply referred to as a “stator vane 46a”.

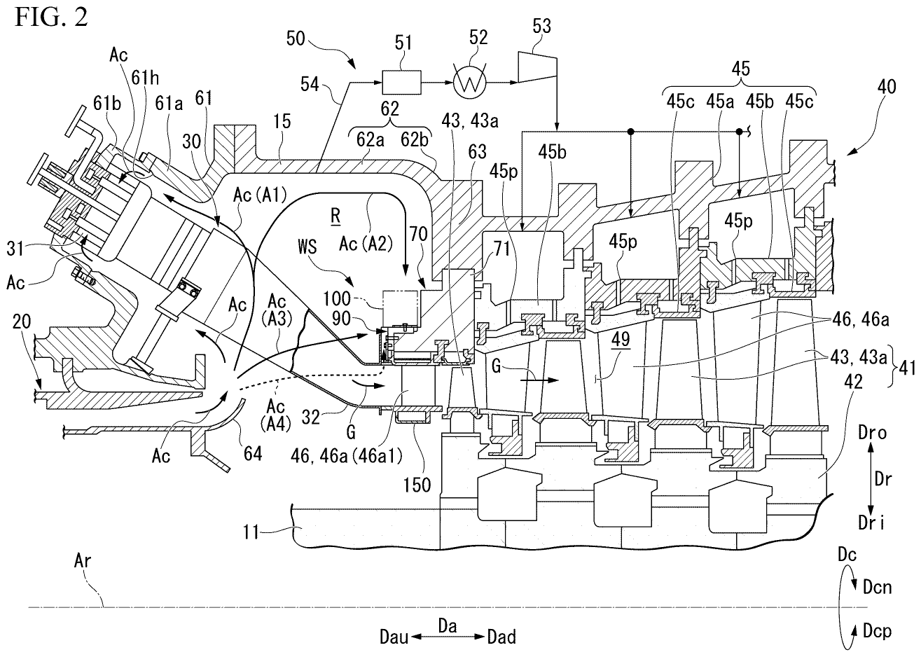

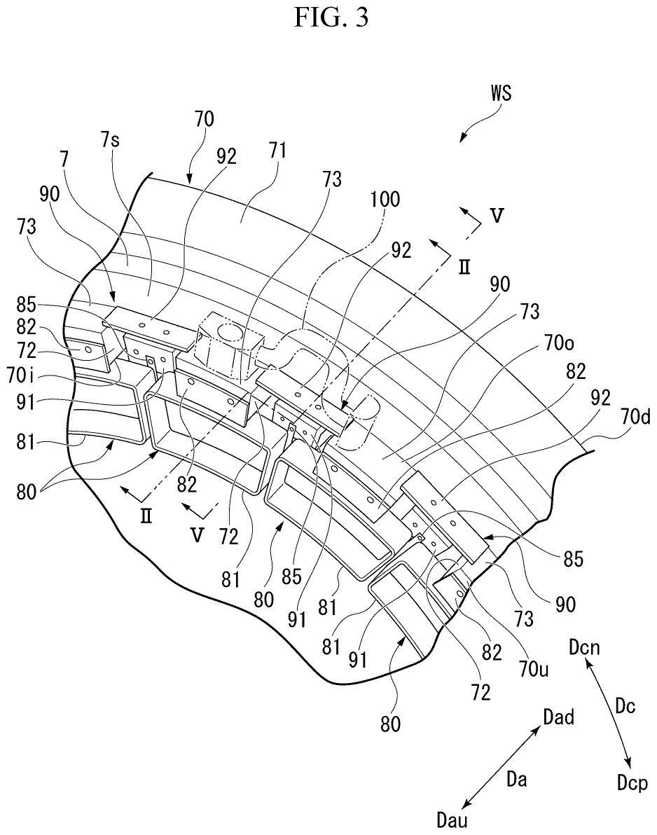

FIG. 2 is an enlarged cross-sectional view showing a part of the gas turbine 10 of the embodiment. In addition, for convenience of description, FIG. 2 schematically shows a cross section of a blade ring assembly WS shown in FIG. 3 taken along line II-II. The turbine casing 45 includes an outer casing 45a that has a tubular shape and constitutes an outer shell of the turbine casing 45, an inner casing 45b that is fixed to the inside of the outer casing 45a, and a plurality of ring segments 45c that are fixed to the inside of the inner casing 45b. Each of the plurality of ring segments 45c is disposed between two adjacent stator vane stages 46 in the plurality of stator vane stages 46. The rotor blade stage 43 is disposed on the radially inner side Dri of each of the ring segments 45c.

A space between the rotor shaft 42 and the turbine casing 45 in the radial direction Dr, in which the stator vane 46a and the rotor blade 43a are disposed, is a flow path through which the combustion gas G flows from the combustor 30. Hereinafter, the flow path through which the combustion gas G flows from the combustor 30 is referred to as a “combustion gas flow path 49”. The combustion gas flow path 49 is formed as an annular space about the axis Ar and is long in the axial direction Da.

The gas turbine 10 in the present embodiment is provided with a cooling device 50 that supplies cooling air to the stator vanes 46a and the ring segment 45c in the second and subsequent stages counted from the axial upstream side Dau. The cooling device 50 includes a foreign matter collector 51, a cooler 52, a booster compressor 53, and a cooling air line 54.

The foreign matter collector 51 is, for example, a strainer having a plurality of pores, and separates the foreign matter included in cooling air flowing through the cooling air line 54. The cooler 52 cools the cooling air flowing through the cooling air line 54. The booster compressor 53 boosts the cooling air flowing through the cooling air line 54. The cooling air line 54 extracts the compressed air Ac in the gas turbine casing 15 as cooling air, and causes the extracted cooling air to pass through the foreign matter collector 51, the cooler 52, and the booster compressor 53 to supply the cooling air to the inside of the outer casing 45a.

A cooling air passage 45p penetrating from the radially outer side Dro to the radially inner side Dri is formed in the inner casing 45b of the turbine casing 45. The cooling air supplied from the cooling air line 54 to the inside of the outer casing 45 a is introduced into the stator vane 46a and the ring segment 45c in the second and subsequent stages passing through the cooling air passage 45p of the inner casing 45b, and is used for cooling the stator vane 46a and the ring segment 45c. Here, since the foreign matter collector 51 is disposed in the cooling air line 54, the foreign matter is unlikely to reach the stator vanes 46a and the ring segment 45c in the second and subsequent stages. The path for supplying the cooling air to the stator vane 46a is not limited thereto.

### Operation of Gas Turbine

Returning to FIG. 1, the operation of the gas turbine 10 will be described. The compressor 20 compresses the air A to generate the compressed air Ac. A part (most) of the compressed air Ac generated by the compressor 20 flows into the combustor 30.

The fuel F is supplied to the combustor 30. In the combustor 30, the fuel F is combusted in the compressed air Ac, and the combustion gas G having a high temperature and a high pressure is generated. The combustion gas G generated by the combustor 30 is sent from the combustor 30 to the combustion gas flow path 49 in the turbine 40. The combustion gas G rotates the turbine rotor 41 in a process of flowing through the combustion gas flow path 49 to the axial downstream side Dad. With the rotation of the turbine rotor 41, the rotor of the generator GEN connected to the gas turbine rotor 11 rotates. As a result, the generator GEN generates electric power.

### Blade Ring Assembly

As shown in FIG. 2, the gas turbine 10 is provided with a blade ring assembly WS. The blade ring assembly WS is disposed on the inner peripheral side of the gas turbine casing 15. The blade ring assembly WS in the present embodiment is disposed on the most upstream side (most axial upstream side Dau) of the turbine 40 in the axial direction Da.

The blade ring assembly WS is provided with a turbine blade ring 70, a plurality of stator vanes 46a1 each forming a plurality of stator vanes 46a in the first stage in the axial direction Da, and the deflector 90. In the first stage stator vane 46a1 in the present embodiment, the compressed air Ac supplied from the compressor 20 into the gas turbine casing 15 is directly supplied as cooling air without passing through the foreign matter collector 51. Therefore, a deflector 90 for preventing the foreign matter included in the compressed air Ac from reaching the stator vane 46a1 is attached to the turbine blade ring 70 in the present embodiment. Hereinafter, this content will be described in detail. In the following, for convenience of description, the compressed air Ac may be referred to as “cooling air Ac”.

### Configuration of Periphery of Blade Ring Assembly

The gas turbine casing 15 includes a front wall 61, a peripheral wall 62, and a rear wall 63 as wall portions that define an accommodation chamber R in which the combustor 30 is accommodated. The accommodation chamber R is a space in the gas turbine casing 15 through which the compressed air Ac flows, and the blade ring assembly WS is exposed to the space.

The front wall 61 is located on the axial upstream side Dau with respect to the accommodation chamber R. The front wall 61 includes a tubular portion 61a having an opening 61h and a tubular lid portion 61b that is attached to the tubular portion 61a and covers the opening 61h. A part of the combustor 30 is disposed inside the tubular portion 61a and the tubular lid portion 61b. For example, an intake portion 31 of the combustor 30 is disposed inside the tubular lid portion 61b.

The peripheral wall 62 is located on the radially outer side Dro with respect to the accommodation chamber R. The peripheral wall 62 extends between the front wall 61 and the rear wall 63 and connects the front wall 61 and the rear wall 63 in the axial direction Da. The peripheral wall 62 includes a first peripheral wall 62a and a second peripheral wall 62b. The first peripheral wall 62a is a portion that is connected to the front wall 61 from the axial downstream side Dad. The first peripheral wall 62a extends in the axial direction Da. The second peripheral wall 62b is located on the axial downstream side Dad with respect to the first peripheral wall 62a in a state of being integrated with the first peripheral wall 62a, and is a portion connected to the rear wall 63. The second peripheral wall 62b is, for example, an inclined portion (reduced-diameter portion) that is inclined to be located on the radially inner side Dri as proceeding to the axial downstream side Dad. The second peripheral wall 62b includes, for example, an arc portion of which the inclination with respect to the axial direction Da becomes steep as proceeding to the axial downstream side Dad.

The rear wall 63 is located on the axial downstream side Dad with respect to the accommodation chamber R. The rear wall 63 is connected to the second peripheral wall 62b from the axial downstream side Dad. The rear wall 63 extends along the radial direction Dr. The rear wall 63 is a partition wall that seals the axial downstream side Dad of the accommodation chamber R. A blade ring fixing portion 71 of a turbine blade ring 70, which will be described later, is fixed to the rear wall 63. The rear wall 63 is located on the axial downstream side Dad with respect to an air intake port 72 of the turbine blade ring 70, which will be described later.

A guide portion 64 that guides the compressed air Ac to the accommodation chamber R is disposed at an inlet portion of the accommodation chamber R as viewed from the compressor 20. The guide portion 64 is, for example, a turning vane disposed in a state of being inclined with respect to the axis Ar. The guide portion 64 changes, for example, a flow direction (flow orientation) of the compressed air Ac flowing from the compressor 20 toward the peripheral wall 62 of the gas turbine casing 15. However, when a part of the compressed air Ac flowing from the compressor 20 is configured to face toward the peripheral wall 62 or the rear wall 63, the guide portion 64 may be omitted.

### Configuration of Blade Ring Assembly

FIG. 3 is a perspective view showing a part of the blade ring assembly WS.

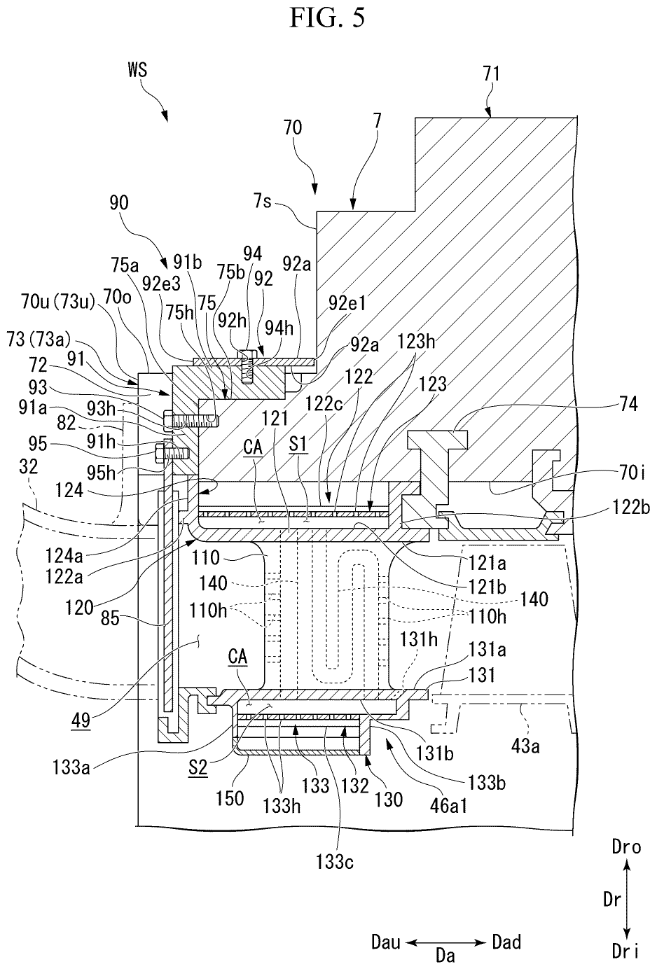

The blade ring assembly WS is provided with the turbine blade ring 70, a plurality of combustor connecting members 80, a plurality of stator vanes 46a1 (not shown in FIG. 3, only one stator vane 46a1 is shown in FIG. 5), a plurality of deflectors 90, a plurality of sealing members 85, and a plurality of shielding covers 150 (not shown in FIG. 3, only one shielding cover 150 is shown in FIG. 5).

### Turbine Blade Ring

The turbine blade ring 70 extends in the circumferential direction Dc about the axis Ar and is formed in an annular shape. The turbine blade ring 70 includes an outer peripheral surface 700, an inner peripheral surface 70i, an upstream-side end surface 70u, and a downstream-side end surface 70d. The outer peripheral surface 700 faces the radially outer side Dro. The outer peripheral surface 700 is exposed to the accommodation chamber R of the gas turbine casing 15. The inner peripheral surface 70i is located on a side opposite to the outer peripheral surface 700 and faces the radially inner side Dri. The inner peripheral surface 70i faces the plurality of stator vanes 46a1. The upstream-side end surface 70u faces the axial upstream side Dau. The downstream-side end surface 70d is located on a side opposite to the upstream-side end surface 70u and faces the axial downstream side Dad.

The turbine blade ring 70 includes a blade ring main body 7, a blade ring fixing portion 71, and a plurality of protruding portions 73. The blade ring main body 7 is formed, for example, in a cylindrical shape. The blade ring fixing portion 71 fixes the blade ring main body 7 to the gas turbine casing 15. The blade ring fixing portion 71 is disposed integrally with the blade ring main body 7 at an end portion of the blade ring main body 7 on the axial downstream side Dad. The blade ring fixing portion 71 is, for example, a flange that protrudes from the blade ring main body 7 to the radially outer side Dro. The blade ring fixing portion 71 is located on the radially inner side Dri of the rear wall 63 of the gas turbine casing 15 (refer to FIG. 2). The blade ring fixing portion 71 is supported in a state of being fixed to the rear wall 63 of the gas turbine casing 15.

As shown in FIG. 3, a plurality of air intake ports 72 are formed in the turbine blade ring 70. The plurality of air intake ports 72 are disposed at predetermined intervals in the circumferential direction Dc over the entire circumference of the turbine blade ring 70. The air intake port 72 penetrates from an outer peripheral surface 700 to an inner peripheral surface 70i of the turbine blade ring 70. The air intake port 72 is located on the axial upstream side Dau with respect to the blade ring fixing portion 71.

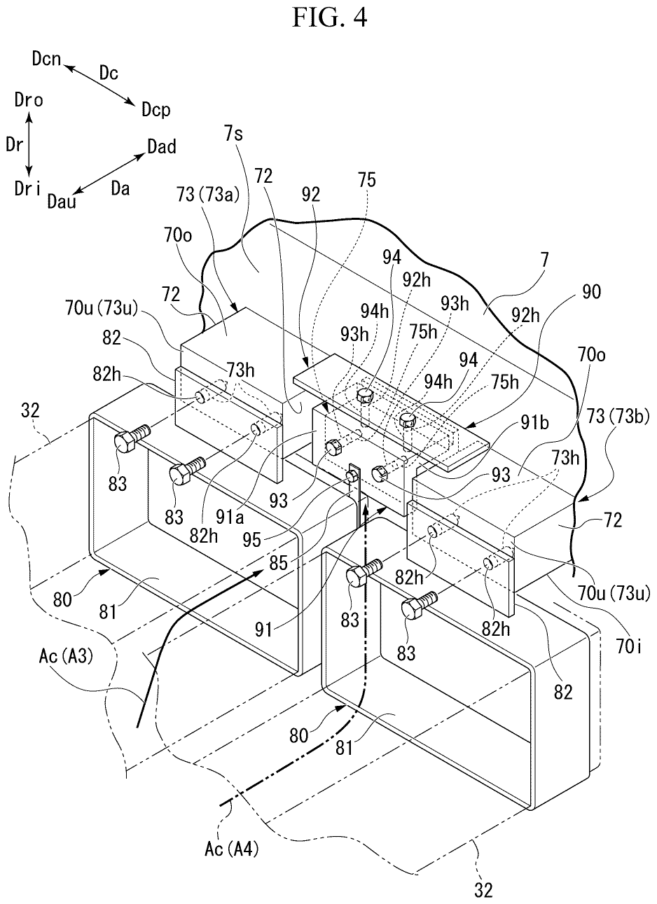

FIG. 4 is a perspective view showing a part of the blade ring assembly WS in an exploded manner. The air intake port 72 in the present embodiment is a cutout portion (groove portion) formed at an end portion of the turbine blade ring 70 on the axial upstream side Dau. That is, the air intake port 72 is open on the axial upstream side Dau in a state of penetrating from the outer peripheral surface 700 to the inner peripheral surface 70i of the turbine blade ring 70. In addition, instead of this, the air intake port 72 may be, for example, a through-hole that penetrates the turbine blade ring 70 from the outer peripheral surface 700 to the inner peripheral surface 70i at a central portion in the axial direction Da. The air intake port 72 guides a part of the cooling air Ac flowing through the accommodation chamber R of the gas turbine casing 15 from the outer peripheral side to the inner peripheral side of the turbine blade ring 70. The air intake port 72 is an example of a “cooling medium intake port”, and the compressed air Ac compressed by the compressor 20 is an example of a “cooling medium”.

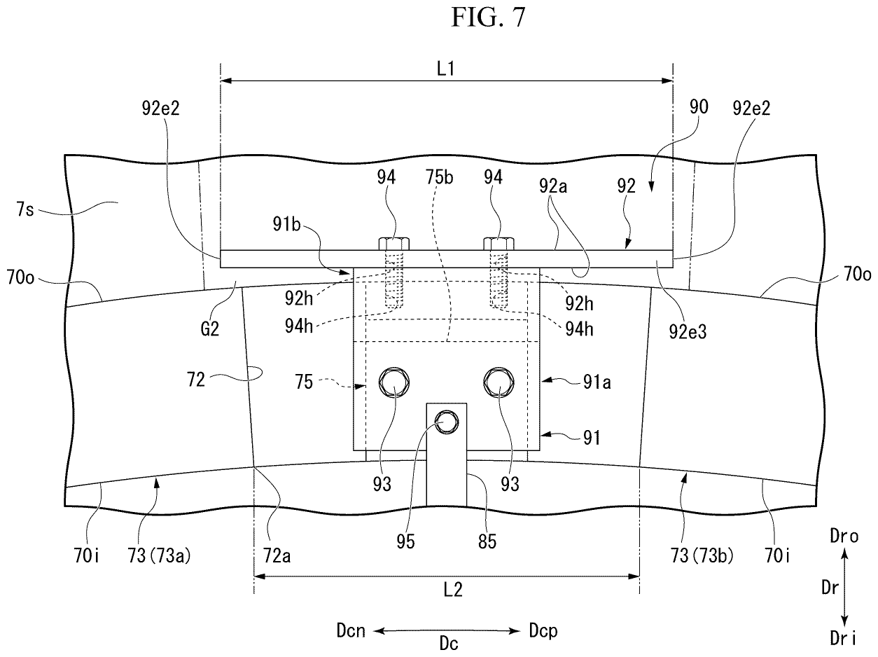

In the present embodiment, the air intake port 72 formed by cutting out an end portion of the turbine blade ring 70 on the axial upstream side Dau forms the plurality of protruding portions 73 protruding from the blade ring main body 7 to the axial upstream side Dau. The plurality of protruding portions 73 are disposed at different positions in the circumferential direction Dc at intervals from each other, and each of the plurality of protruding portions 73 protrudes from an end surface of the blade ring main body 7 facing the axial upstream side Dau toward the axial upstream side Dau. Hereinafter, the end surface of the blade ring main body 7 facing the axial upstream side Dau will be referred to as an “upstream surface 7s”. The end surface of the plurality of protruding portions 73 on the axial upstream side Dau forms the upstream-side end surface 70u of the turbine blade ring 70 described above. The plurality of protruding portions 73 and the plurality of air intake ports 72 are alternately disposed in the circumferential direction Dc (refer to FIG. 3). Therefore, as shown in FIG. 4, in a case where one air intake port 72 is focused, the plurality of protruding portions 73 include a first protruding portion 73a located on a side of the air intake port 72 in the circumferential direction Den and a second protruding portion 73b located on a side of the air intake port 72 in the circumferential direction Dcp. The first protruding portion 73a and the second protruding portion 73b form the air intake port 72 that communicates from the outer peripheral side to the inner peripheral side of the turbine blade ring 70 together with the blade ring main body 7. In other words, the air intake port 72 is located between the first protruding portion 73a and the second protruding portion 73b in the circumferential direction Dc. The air intake port 72 in the present embodiment is formed to be narrower toward the radially inner side Dri (refer to FIG. 7). Hereinafter, for convenience of description, the narrowest portion of the air intake port 72 located closest to the radially inner side Dri may be referred to as a “narrow portion 72a”. The narrow portion 72a is formed, for example, between an end portion of the first protruding portion 73a on the radially inner side Dri and an end portion of the second protruding portion 73b on the radially inner side Dri. The narrow portion 72a is an example of a “minimum portion”.

As shown in FIG. 5, the blade ring main body 7 in the present embodiment includes a deflector fixing portion 75 that protrudes from the upstream surface 7s between the first protruding portion 73a and the second protruding portion 73b. The deflector fixing portion 75 is disposed, for example, at a central position between the first protruding portion 73a and the second protruding portion 73b (refer to FIG. 4). The deflector fixing portion 75 is disposed in the air intake port 72 with a gap between the first protruding portion 73a and the second protruding portion 73b in the circumferential direction Dc (refer to FIG. 4). As shown in FIG. 5, the deflector fixing portion 75 includes a support surface 75b facing the radially outer side Dro and a fixing surface 75a which is perpendicular to the support surface 75b and faces the axial upstream side Dau. A deflector 90, which will be described later, is attached to the support surface 75b and the fixing surface 75a. A coupling hole 75h to which a coupling tool 93 such as a bolt can be coupled is formed in the fixing surface 75a of the deflector fixing portion 75. A plurality of (for example, two) coupling holes 75h are disposed on the fixing surface 75a.

As shown in FIG. 3, a cooling medium circulation portion 100 is provided between the first protruding portion 73a and the second protruding portion 73b adjacent to each other. The cooling medium circulation portion 100 connects the first protruding portion 73a and the second protruding portion 73b to each other to straddle the first protruding portion 73a and the second protruding portion 73b. The cooling medium circulation portion 100 circulates the cooling medium in a cooling flow path (not shown) formed in the blade ring main body 7.

In the present disclosure, steam, air, or the like is used as the cooling medium, but the cooling medium is not limited thereto, and a medium having fluidity and capable of being used for cooling the blade ring main body 7 is appropriately adopted. The cooling medium circulation portion 100 is provided on the radially outer side Dro of the turbine blade ring 70 and overlaps the air intake port 72 in a case of being viewed in the radial direction Dr. The cooling medium circulation portion 100 is an example of a “forced cooling component”.

### Combustor Connecting Member

Next, the combustor connecting member 80 will be described. The combustor connecting member 80 is a fixing component to which a tail tube 32 of the combustor 30 is fixed. As shown in FIG. 3, the plurality of combustor connecting members 80 are provided at positions corresponding to the plurality of protruding portions 73 of the turbine blade ring 70 in the circumferential direction Dc. As shown in FIGS. 3 and 4, the combustor connecting member 80 includes a frame portion 81 and a flange 82.

The frame portion 81 is a portion to which the tail tube 32 of the combustor 30 is connected. The tail tube 32 of the combustor 30 is fixed to the frame portion 81 by welding, for example. The flange 82 is a portion extending from the frame portion 81 to the radially outer side Dro. The flange 82 has a planar shape along the circumferential direction Dc and the radial direction Dr. The flange 82 faces an end surface 73u of the protruding portion 73 on the axial upstream side Dau in the axial direction Da. A coupling hole 73h to which a coupling tool 83 such as a bolt can be coupled is formed on the end surface 73u of the protruding portion 73 on the axial upstream side Dau.

An insertion hole 82h through which the coupling tool 83 is passed is formed in the flange 82. The coupling tool 83 passed through the insertion hole 82h of the flange 82 is coupled to the coupling hole 73h of the protruding portion 73, and thus the flange 82 is fixed to the protruding portion 73. The end surface 73u of the protruding portion 73 including the coupling hole 73h is an example of a “connecting portion” that can be connected to the combustor connecting member 80. In the present embodiment, the end surface 73u of each of the first protruding portion 73a and the second protruding portion 73b described above includes the coupling hole 73h, and the combustor connecting member 80 is attached thereto.

### Stator Vane

Next, the stator vane 46a1 will be described.

FIG. 5 is a cross-sectional view taken along line V-V of the blade ring assembly WS shown in FIG. 3. The plurality of stator vanes 46a1 (only one is shown in FIG. 5) are disposed on the inner peripheral side of the turbine blade ring 70 and are disposed side by side in the circumferential direction Dc. The stator vane 46a1 is held by a holding member 74 provided in the turbine blade ring 70. The stator vane 46a1 includes a blade body 110, an outer shroud 120, an inner shroud 130, and an air passage 140.

The blade body 110 has a wing shape in cross section and extends in the radial direction Dr. That is, the wing height direction of the blade body 110 is the radial direction Dr. The blade body 110 is disposed in the combustion gas flow path 49 through which the combustion gas G passes. On the surface of the blade body 110, among the surfaces facing the circumferential direction Dc, a projecting surface forms a rear side surface (negative pressure surface), and a recessed surface forms an abdominal side surface (positive pressure surface). A plurality of exhaust holes 110h are formed at an end portion on the axial upstream side Dau and an end portion on the axial downstream side Dad of the blade body 110.

The outer shroud 120 is provided at an end of the blade body 110 on the radially outer side Dro and defines an outer peripheral side position of the combustion gas flow path 49 as a space forming an annular shape.

The outer shroud 120 includes a shroud main body 121, a peripheral wall 122, a retainer 124, and a collision plate 123.

The shroud main body 121 is formed in a plate shape that extends in the axial direction Da and the circumferential direction Dc. The shroud main body 121 includes a Ggas path surface 121a and an outside inner surface 121b. The Ggas path surface 121a is a surface in contact with the combustion gas G (a surface facing the combustion gas flow path 49) and faces the radially inner side Dri. The outside inner surface 121b is a surface facing a side opposite to the Ggas path surface 121a.

The peripheral wall 122 protrudes from the shroud main body 121 in the radially outer side Dro along the outer peripheral edge of the shroud main body 121. The peripheral wall 122 in the present embodiment is formed over the entire circumference of the outer peripheral edge of the shroud main body 121. The peripheral wall 122 includes a front wall portion 122a having a front wall facing the axial downstream side Dad, a rear wall portion 122b having a rear wall facing the axial upstream side Dau, a rear-side wall portion 122c having a rear-side wall facing the circumferential direction Dcp, and a ventral-side wall portion (not shown) having a ventral-side wall facing the circumferential direction Den. Therefore, the outer shroud 120 has a first space S1 which is a space surrounded by the peripheral wall 122 in four directions.

The retainer 124 is disposed on the radially outer side Dro of the front wall portion 122a of the peripheral wall 122. The retainer 124 extends integrally with the front wall portion 122a to the radially outer side Dro from the front wall portion 122a. The end portion of the retainer 124 on the radially outer side Dro is fixed to, for example, the deflector fixing portion 75 of the blade ring main body 7. The retainer 124 has a front surface 124a facing the axial upstream side Dau.

The collision plate 123 is disposed in the first space S1 of the outer shroud 120 and divides the first space S1 into a region on the radially outer side Dro and a cavity CA which is a region on the radially inner side Dri. A plurality of air holes 123h penetrating in the radial direction Dr are formed in the collision plate 123. A part of the cooling air Ac present on the radially outer side Dro of the stator vane 46al flows into the cavity CA through the plurality of air holes 123h formed in the collision plate 123. A part of the air that has flowed into the cavity CA is exhausted to the combustion gas flow path 49 from, for example, an exhaust hole (not shown) provided in the outer shroud 120 after the outer shroud 120 is cooled.

The inner shroud 130 is provided at an end of the blade body 110 on the radially inner side Dri and defines an inner peripheral side position of the combustion gas flow path 49 as a space forming an annular shape. The inner shroud 130 includes a shroud main body 131, a peripheral wall 132, and a collision plate 133.

The shroud main body 131 is formed in a plate shape that extends in the axial direction Da and the circumferential direction Dc. The shroud main body 131 includes a Ggas path surface 131a and an inside inner surface 131b. The Ggas path surface 131a is a surface in contact with the combustion gas G (a surface facing the combustion gas flow path 49) and faces the radially outer side Dro. The inside inner surface 131b is a surface facing a side opposite to the Ggas path surface 131a. The shroud main body 131 includes an exhaust hole 131h that communicates a second space S2, which will be described later, with the combustion gas flow path 49.

The peripheral wall 132 protrudes from the shroud main body 131 on the radially inner side Dri along the outer peripheral edge of the shroud main body 131. The peripheral wall 132 in the present embodiment is formed over the entire circumference of outer peripheral edge of the shroud main body 131. The peripheral wall 132 includes a front wall portion 133a having a front wall facing the axial downstream side Dad, a rear wall portion 133b having a rear wall facing the axial upstream side Dau, a rear-side wall portion 133c having a rear-side wall facing the circumferential direction Dcp, and a ventral-side wall portion (not shown) having a ventral-side wall facing the circumferential direction Den. The inner shroud 130 has a second space S2 which is a space surrounded by the peripheral wall 132 in four directions.

The collision plate 133 is provided in the second space S2 of the inner shroud 130 and divides the second space S2 into a region on the radially inner side Dri and a cavity CA which is a region on the radially outer side Dro. A plurality of air holes 133h that penetrate in the radial direction Dr are formed in the collision plate 133. The collision plate 133 may be omitted.

A plurality of air passages 140 extend from the outer shroud 120 through the blade body 110 to the inner shroud 130. A part of the adjacent air passages 140 among the plurality of air passages 140 may communicate with each other in a portion on the radially outer side Dro or a portion on the radially inner side Dri. Any of the plurality of air passages 140 communicates with the first space S1 of the outer shroud 120. Any of the plurality of air passages 140 communicates with the second space S2 of the inner shroud 130. The air passage 140 communicates with the plurality of exhaust holes 110h of the blade body 110.

A part of the cooling air Ac that has flowed into the inner peripheral side of the turbine blade ring 70 through the air intake port 72 of the turbine blade ring 70 flows into the air holes 123h of the collision plate 123 of the outer shroud 120 and flows through the cavity CA of the outer shroud 120 to cool the outer shroud 120. Another part of the cooling air Ac that has flowed into the inner peripheral side of the turbine blade ring 70 flows into the air passage 140 and cools the blade body 110 in the process of passing through the air passage 140. A part of the cooling air Ac flowing through the air passage 140 is exhausted from the plurality of exhaust holes 110h provided in the blade body 110 to the combustion gas flow path 49. Another part of the cooling air Ac that has flowed through the air passage 140 flows into the second space S2 of the inner shroud 130 and cools the inner shroud 130. The cooling air Ac that has flowed through the second space S2 of the inner shroud 130 is exhausted from the exhaust hole 131h of the inner shroud 130 to the combustion gas flow path 49.

### Deflector

Next, the Deflector 90 Will Be Described.

As shown in FIG. 3, the plurality of deflectors 90 are disposed on at least a part of the outer peripheral side of the turbine blade ring 70. The plurality of deflectors 90 are disposed separately in the circumferential direction Dc and are located corresponding to the plurality of air intake ports 72. The deflector 90 and the turbine blade ring 70 are formed of a material (for example, stainless steel) having the same composition, and have the same thermal expansion coefficient. The term “same composition” means, for example, that the material used in manufacturing the turbine blade ring 70 and the material used in manufacturing the deflector 90 are the same.

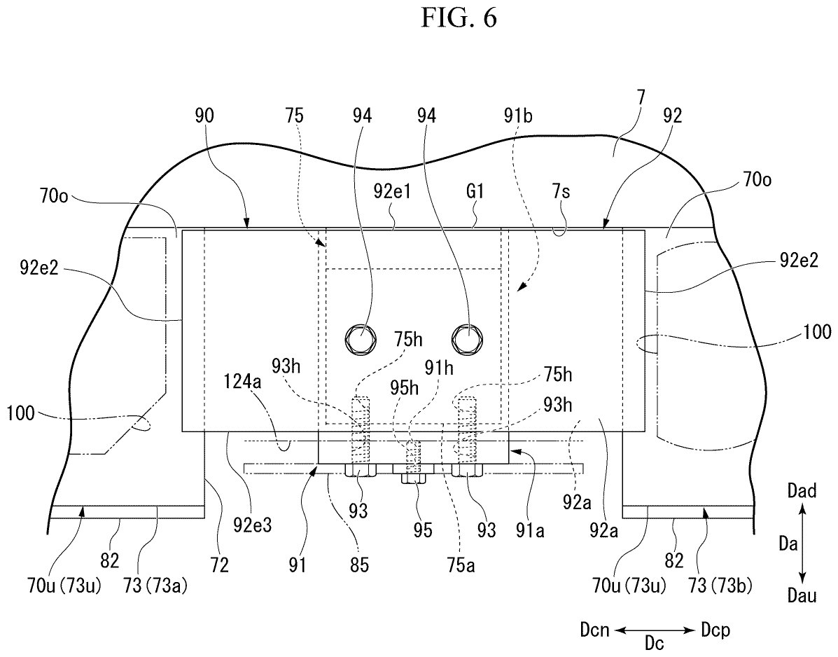

FIG. 6 is a plan view of the deflector 90 when the deflector 90 is viewed from the radially outer side Dro. FIG. 7 is a front view of the deflector 90 when the deflector 90 is viewed from the axial upstream side Dau. As shown in FIG. 6, the deflector 90 is disposed to shield at least a part of the air intake port 72 in a case of being viewed from the radially outer side Dro. As shown in FIGS. 3 to 7, the deflector 90 includes a fixed base portion 91 and a plate portion 92.

### Fixed Base Portion

The fixed base portion 91 is disposed between two protruding portions 73 (the first protruding portion 73a and the second protruding portion 73b) adjacent to each other in the circumferential direction Dc, and is attached to the turbine blade ring 70. The fixed base portion 91 in the present embodiment is attachably and detachably fixed to the deflector fixing portion 75 of the blade ring main body 7. The fixed base portion 91 includes a first portion 91a that abuts on the fixing surface 75a of the deflector fixing portion 75 from the axial upstream side Dau and a second portion 91b that abuts on the support surface 75b of the deflector fixing portion 75 from the radially outer side Dro. Each of the first portion 91a and the second portion 91b has a plate shape having a predetermined thickness, and are integrated with each other in a state where end portions thereof are connected to each other. The fixed base portion 91 has an L-shape as viewed in the circumferential direction Dc.

An insertion hole 93h through which the coupling tool 93 is passed is formed in the first portion 91a of the fixed base portion 91. The coupling tool 93 passed through the insertion hole 93h of the first portion 91a is coupled to the coupling hole 75h of the deflector fixing portion 75, and thus the first portion 91a and the second portion 91b integrated with the first portion 91a are fixed to the deflector fixing portion 75. That is, the fixed base portion 91 is attachable to and detachable from the deflector fixing portion 75 by the coupling tool 93.

In addition, the first portion 91a is provided with a coupling hole 91h through which a coupling tool 95 such as a bolt is passed. The first portion 91a including the coupling hole 91h is an example of a “fixing portion” to which the sealing member 85 can be fixed. In the present embodiment, the first portion 91a described above includes the coupling hole 91h, and the sealing member 85 is attached thereto. Therefore, the first portion 91a including the coupling hole 91h for fixing the deflector 90 to the turbine blade ring 70 is disposed between the two protruding portions 73 in the circumferential direction Dc.

In addition, a coupling hole 94h to which a coupling tool 94 such as a bolt can be coupled is provided on a surface of the second portion 91b facing the radially outer side Dro. A plurality of (for example, two) coupling holes 94h are disposed on the end surface of the second portion 91b facing the radially outer side Dro.

### Plate Portion

The plate portion 92 is attached to the fixed base portion 91. The plate portion 92 is attached to an end portion of the fixed base portion 91 on the radially outer side Dro and is supported by the fixed base portion 91. The plate portion 92 has, for example, a plate shape along a direction intersecting (for example, orthogonal to) the radial direction Dr. The plate portion 92 has, for example, a main surface 92a that extends in a direction intersecting the radial direction Dr (for example, a direction orthogonal to the radial direction Dr). In the present embodiment, the plate portion 92 has a pair of main surfaces 92a that are located to face the radially outer side Dro and the radially inner side Dri when the plate portion 92 is attached to the fixed base portion 91. The main surface 92a of the pair of main surfaces 92a of the plate portion 92 facing the radially inner side Dri abuts on a surface of the second portion 91b of the fixed base portion 91 facing the radially outer side Dro.

An insertion hole 92h through which the coupling tool 94 is passed is formed in the plate portion 92. The insertion hole 92h penetrates the pair of main surfaces 92a in the plate thickness direction of the plate portion 92. The coupling tool 94 passed through the insertion hole 92h of the plate portion 92 is coupled to the coupling hole 94h of the second portion 91b, and thus the plate portion 92 is fixed to the second portion 91b of the fixed base portion 91. That is, the plate portion 92 is attachable to and detachable from the fixed base portion 91 by the coupling tool 94. Therefore, the fixed base portion 91 can be detached from the turbine blade ring 70 in a state where the plate portion 92 and the fixed base portion 91 are integrated with each other.

As shown in FIG. 6, the plate portion 92 is disposed to overlap at least a part of each of the two protruding portions 73 (the first protruding portion 73a and the second protruding portion 73b) adjacent to each other in the circumferential direction De in a case of being viewed from the radially outer side Dro. In addition, the plate portion 92 is disposed with a gap between the plate portion 92 and the upstream surface 7s of the blade ring main body 7 in a case of being viewed from the radially outer side Dro. Hereinafter, the gap formed between the plate portion 92 and the upstream surface 7s of the blade ring main body 7 in a case of being viewed from the radially outer side Dro is referred to as a “gap G1”. Here, the plate portion 92 includes a first end portion 92e1 which is an end portion on the axial downstream side Dad, a pair of second end portions 92e2 which are both end portions in the first direction (the left-right direction in FIGS. 6 and 7) in which the two protruding portions are adjacent to each other, and a third end portion 92e3 which is an end portion on the axial upstream side Dau. That is, the first end portion 92e1 is disposed with the gap G1 between the first end portion 92e1 and the upstream surface 7s of the turbine blade ring 70. The first end portion 92e1 and the third end portion 92e3 extend in the first direction. The second end portion 92e2 extends in the axial direction Da.

In addition, as shown in FIG. 7, the plate portion 92 is disposed with a gap between the plate portion 92 and the two protruding portions 73 in the radial direction Dr. Hereinafter, the gap between the plate portion 92 and the two protruding portions 73 on the radially outer side Dro is referred to as a “gap G2”. That is, the second end portion 92e2 is disposed with the gap G2 between the second end portion 92e2 and the two protruding portions 73. Furthermore, a width L1 of the plate portion 92 in the first direction where the two protruding portions 73 are adjacent to each other is wider than a width L2 of the narrow portion 72a of the air intake port 72 in the first direction in a case of being viewed in the radial direction. The width L1 of the plate portion 92 is the distance of separation between the pair of second end portions 92e2 in the first direction.

In addition, as shown in FIG. 6, the ratio at which the deflector 90 shields the air intake port 72 in a case of being viewed from the radially outer side Dro is higher than the ratio at which the deflector 90 shields the air intake port 72 in a case of being viewed from the axial upstream side Dau as shown in FIG. 7. That is, the ratio at which the fixed base portion 91 and the plate portion 92 shields the air intake port 72 in the radial direction Dr as viewed from the radially outer side Dro is higher than the ratio at which the fixed base portion 91 and the plate portion 92 shields the air intake port 72 in the axial direction Da as viewed from the axial upstream side Dau.

In addition, as shown in FIG. 5, the third end portion 92e3 of the plate portion 92 is located on the axial downstream side Dad with respect to the front surface 124a of the retainer 124 included in the stator vane 46a1. In addition, the third end portion 92e3 is located on the axial downstream side Dad with respect to the surface of the fixed base portion 91 facing the axial upstream side Dau. In addition, the third end portion 92e3 is located on the axial downstream side Dad with respect to the end surface 73u of the protruding portion 73 facing the axial upstream side Dau.

In addition, as shown in FIG. 3, the deflector 90 is disposed on the inner peripheral side of the cooling medium circulation portion 100. In addition, the plate portion 92 is located between the cooling medium circulation portion 100 and the air intake port 72 in the radial direction Dr.

### Sealing Member

As shown in FIGS. 3 to 7, the sealing member 85 is disposed between the tail tubes 32 of two combustors 30 adjacent to each other in the circumferential direction Dc, and airtightly seals the gap between the tail tubes 32 of two combustors 30. For example, a spring seal is adopted as the sealing member 85. The sealing member 85 is disposed on the inner peripheral side of the turbine blade ring 70 (refer to FIG. 5). The sealing member 85 is disposed at a position overlapping the air intake port 72 in the radial direction Dr (refer to FIGS. 5 and 6). The sealing member 85 can be detached on the outer peripheral side of the turbine blade ring 70 through the air intake port 72 in a state where the tail tube 32 of the combustor 30 is detached from the combustor connecting member 80.

The sealing member 85 is provided with an insertion hole 95h through which the coupling tool 95 is passed. The coupling tool 95 passed through the insertion hole 95h of the sealing member 85 is coupled to the coupling hole 91h of the first portion 91a of the fixed base portion 91, and thus the sealing member 85 is fixed to the first portion 91a. That is, the sealing member 85 is attachable to and detachable from the fixed base portion 91 by the coupling tool 95.

### Shielding Cover

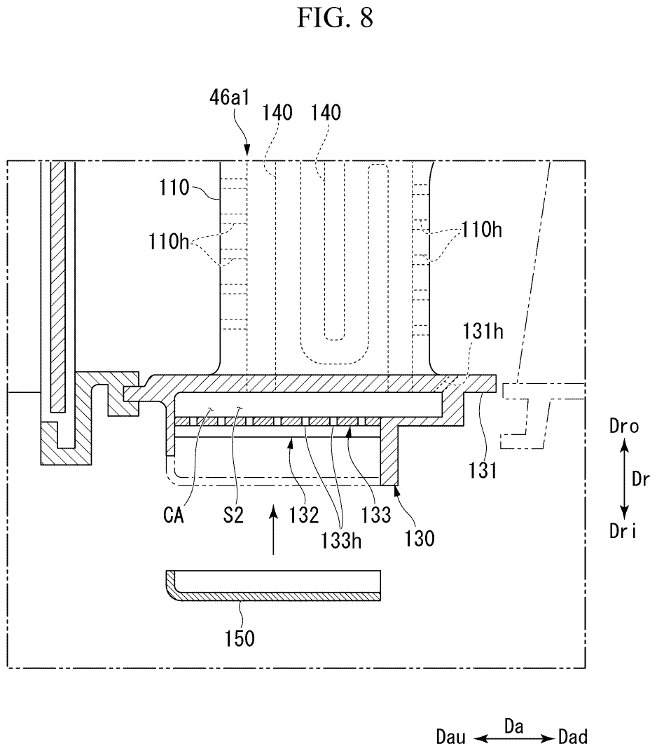

FIG. 8 is a cross-sectional view showing the shielding cover 150. The shielding cover 150 is attached to the inner shroud 130 and is fixed to the inner shroud 130 by welding or the like. The shielding cover 150 covers at least a part of the second space S2 of the inner shroud 130 from the radially inner side Dri. The shielding cover 150 in the present embodiment is attached to the peripheral wall 132 of the inner shroud 130 and covers the entire second space S2 of the inner shroud 130. When the shielding cover 150 is attached to the inner shroud 130, the compressed air Ac is not supplied to the second space S2 of the inner shroud 130 from the radially inner side Dri. The compressed air Ac, which flows from the air intake port 72 of the turbine blade ring 70 and flows through the outer shroud 120 and the air passage 140 of the blade body 110, is supplied to the second space S2 of the inner shroud 130.

### Actions/Effects

Next, the actions and effects exhibited by the configuration of the present embodiment will be described.

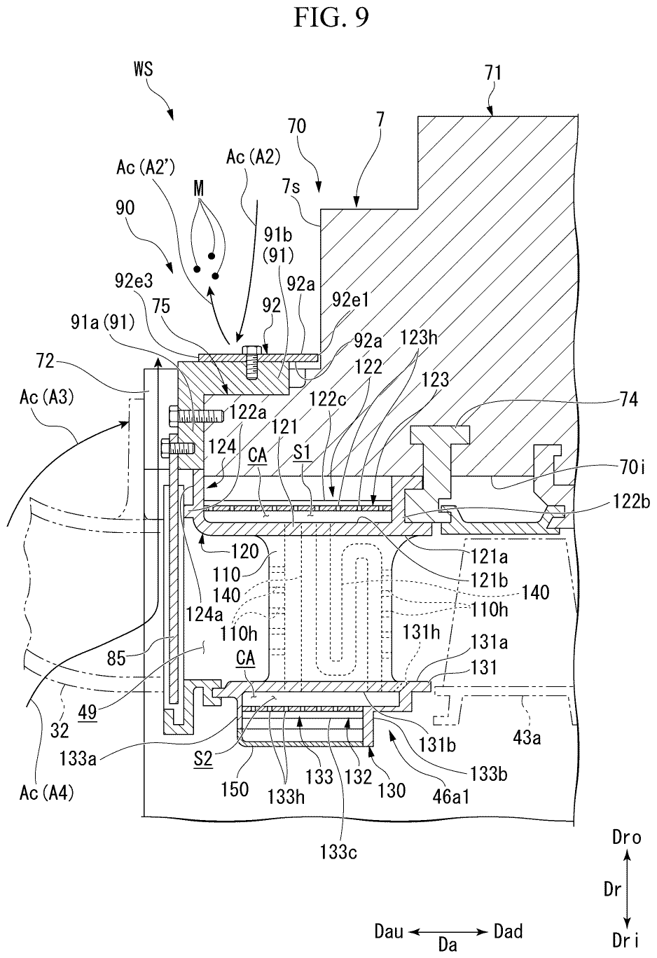

As shown in FIG. 2, the compressed air Ac compressed by the compressor 20 is supplied from the compressor 20 to the accommodation chamber R in which the combustor 30 is disposed. A part of the compressed air Ac supplied to the accommodation chamber R flows toward the peripheral wall 62 of the gas turbine casing 15, with the angle in the flow direction changed by the guide portion 64. The compressed air Ac that has collided with the peripheral wall 62 (first peripheral wall 62a) is divided into two parts, for example. That is, a part (for example, most) of the compressed air Ac changes the flow direction to flow toward the intake portion 31 of the combustor 30, and flows toward the intake portion 31 of the combustor 30 (refer to arrow A1 in FIG. 2). On the other hand, another part of the compressed air Ac changes the flow direction to flow along the rear wall 63 from the peripheral wall 62 after colliding with the peripheral wall 62 of the gas turbine casing 15 (refer to arrow A2 in FIG. 2). As a result, in the inside of the accommodation chamber R, a flow of the compressed air Ac from the radially outer side Dro toward the radially inner side Dri in a space located on the radially outer side Dro with respect to the turbine blade ring 70 (refer to arrow A2 in FIGS. 2 and 9) is generated. A part of the flow of the compressed air Ac is attempted to be taken in from the air intake port 72 of the turbine blade ring 70 to the inner peripheral side of the turbine blade ring 70.

In addition, as shown in FIGS. 2 and 4, after the angle of the flow direction of a part of the compressed air Ac supplied to the accommodation chamber R is changed by the guide portion 64, a flow of the compressed air directly from the axial upstream side Dau toward the air intake port 72 (refer to arrow A3 in FIGS. 2 and 4) is generated. At the same time, the compressed air Ac collides with the sealing member 85 that airtightly seals the gap between two tail tubes 32 of the combustor 30, and a flow of the compressed air Ac from the radially inner side Dri toward the radially outer side Dro (refer to arrow A4 in FIGS. 2 and 4) is generated along the sealing member 85.

FIG. 9 is a cross-sectional view showing an action of the deflector 90.

In the present embodiment, the deflector 90 is attached to the turbine blade ring 70. The deflector 90 includes the plate portion 92 that is disposed to shield at least a part of the air intake port 72 in a case of being viewed in the radial direction Dr. Therefore, most of the compressed air Ac flowing along the rear wall 63 of the gas turbine casing 15 does not flow into the air intake port 72 as it is, but collides with the plate portion 92 of the deflector 90 and bounces back (refer to arrows A2 and A2′ in FIG. 9). In this process, a foreign matter M (for example, rust or dust) included in the compressed air Ac flows to the axial upstream side Dau to be spaced apart from the air intake port 72. Therefore, the foreign matter M included in the compressed air Ac is unlikely to enter the air intake port 72 from the radially outer side Dro. As a result, the foreign matter M is prevented from clogging the cooling structure of the stator vane 46a1 (for example, the exhaust hole 110h of the blade body 110 or the exhaust hole 131h of the inner shroud 130).

The foreign matter M that flows to the axial upstream side Dau to be spaced apart from the air intake port 72 by the compressed air Ac bouncing back is taken into the combustor 30 from the intake portion 31 of the combustor 30, for example, and is included in the combustion gas G to be discharged to the outside of the gas turbine 10. Since the combustion gas flow path 49 has fewer or no small holes that can be clogged with the foreign matter compared to the stator vane 46a1, the foreign matter M is unlikely to cause a problem.

In addition, according to the configuration described in the present embodiment, the above-described action can be realized with a simple configuration such as the plate portion 92. Therefore, for example, an increase in the cost required for manufacturing the deflector 90 can be prevented.

In addition, as shown in FIG. 7, the width L1 of the plate portion 92 in the first direction where the two protruding portions 73 are adjacent to each other is wider than the width L2 of the narrow portion 72a of the cooling medium intake port 72 in the first direction in a case of being viewed in the radial direction Dr. Therefore, for example, compared to a case where the width L1 of the plate portion 92 is the same as or narrower than the width L2 of the narrow portion 72a, the compressed air Ac is unlikely to flow into the inner peripheral side of the turbine blade ring 70 from the radially outer side Dro through the air intake port 72.

In addition, as shown in FIG. 6, the first end portion 92e1 of the plate portion 92 is disposed with the gap G1 between the first end portion 92e1 and the upstream surface 7s of the blade ring main body 7 in a case of being viewed from the radially outer side Dro. Furthermore, as shown in FIG. 7, the pair of second end portions 92e2 of the plate portion 92 is disposed with the gap G2 between the pair of second end portions 92e2 and the two protruding portions 73 in a case of being viewed from the axial upstream side Dau. Therefore, even when a tolerance occurs in dimensions such as length, width, and thickness in the manufacturing process of the plate portion 92, since there are the gaps G1 and G2, it is possible to prevent the interference of the plate portion 92 with the turbine blade ring 70. As a result, for example, the number of man-hours required for the assembly of the blade ring assembly WS can be reduced.

In addition, as shown in FIG. 5, the third end portion 92e3 of the plate portion 92 is located on the axial downstream side Dad with respect to the front surface 124a of the retainer 124 included in the stator vane 46a1. Therefore, for example, compared to a case where the third end portion 92e3 is located at the same position as the front surface 124a of the retainer 124 in the axial direction Da or is located on the axial upstream side Dau with respect to the front surface 124a, the foreign matter M included in the compressed air Ac (refer to arrow A3 in FIGS. 2, 4, and 9) flowing from the axial upstream side Dau is unlikely to collide with the main surface 92a of the plate portion 92 facing the radially inner side Dri and bounce back. As a result, the foreign matter M is unlikely to be taken into the air intake port 72. In addition, the foreign matter M included in the compressed air Ac (refer to arrow A4 in FIG. 2, FIG. 4, and FIG. 9) flowing from the radially inner side DrI is unlikely to collide with the main surface 92a of the plate portion 92 facing the radially inner side DrI and bounce back. As a result, the foreign matter M is unlikely to be taken into the air intake port 72.

In addition, according to the configuration described in the present embodiment, the fixed base portion 91 of the deflector 90 is disposed between the two protruding portions 73 in the circumferential direction Dc, is attached to the turbine blade ring 70, and the plate portion 92 is attached to the outer end portion of the fixed base portion 91 in the radial direction Dr. As a result, the fixed base portion 91 in the cooling medium intake port can support the plate portion 92 from the radially inner side Dri. Therefore, when the compressed air Ac collides with the plate portion 92 from the radially outer side Dro, it is possible to prevent the plate portion 92 from being displaced to the radially inner side Dri.

In addition, according to the configuration described in the present embodiment, the third end portion 92e3 of the plate portion 92 is located on the axial downstream side Dad with respect to the surface of the fixed base portion 91 facing the axial upstream side Dau. Therefore, the foreign matter M included in the compressed air Ac flowing from the radially outer side Dro with respect to the fixed base portion 91 collides with the main surface 92a of the plate portion 92 facing the radially inner side Dri and is unlikely to bounce back, as compared with a case where the third end portion 92e3 is located at the same position in the axial direction Da as the surface of the fixed base portion 91 facing the axial upstream side Dau or is located on the axial upstream side Dau with respect to the surface. As a result, the foreign matter M is unlikely to be taken into the air intake port 72.

In addition, according to the configuration described in the present embodiment, the fixed base portion 91 can be detached from the turbine blade ring 70 in a state where the plate portion 92 and the fixed base portion 91 are integrated with each other. Therefore, for example, even when a forced cooling component, such as the cooling medium circulation portion 100, is present as an interfering object on the radially outer side Dro with respect to the plate portion 92, the fixed base portion 91 can be detached toward the axial upstream side Dau in a state of being integrated with the plate portion 92. As a result, for example, compared to a case where the fixed base portion 91 and the plate portion 92 are not integrated with each other, it is possible to easily perform maintenance such as repair on the fixed base portion 91 and the plate portion 92.

In addition, according to the configuration described in the present embodiment, the fixed base portion 91 includes the first portion 91a to which the sealing member 85 that airtightly seals the gap between two tail tubes 32 of the combustor 30 adjacent to each other in the circumferential direction Dc is fixed. That is, the fixed base portion 91 is a member that supports the plate portion 92 from the radially inner side Dri and also serves as a member for fixing the sealing member 85. Therefore, it is not necessary to provide a member other than the fixed base portion 91 in order to fix the sealing member 85. As a result, it is possible to prevent an increase in the number of components of the turbine blade ring 70.

In addition, according to the configuration described in the present embodiment, each of the plurality of protruding portions 73 includes the end surface 73u including the coupling hole 73h that is connectable to the combustor connecting member 80 to which the tail tube 32 of the combustor 30 is fixed. Therefore, by using the protruding portion 73, the length of the plate portion 92 can be made relatively long in the axial direction Da.

Therefore, the foreign matter M included in the compressed air Ac flowing from the radially outer side Dro toward the deflector 90 is prevented from flowing into the air intake port 72.

In addition, according to the configuration described in the present embodiment, since the turbine blade ring 70 and the deflector 90 are formed of a material having the same composition, for example, the influence of thermal expansion of the turbine blade ring 70 acting between the turbine blade ring 70 and the deflector 90 can be kept small. Therefore, for example, it is possible to prevent the occurrence of a problem between the turbine blade ring 70 and the first portion 91a of the fixed base portion 91. As a result, the life of the blade ring assembly WS can be extended.

In addition, as shown in FIGS. 6 and 7, the ratio at which the deflector 90 shields the air intake port 72 in the radial direction Dr as viewed from the radially outer side Dro is higher than the ratio at which the deflector 90 shields the air intake port 72 as viewed from the axial upstream side Dau. As a result, the amount of the cooling air Ac taken in from the axial upstream side Dau to the air intake port 72 is larger than the amount of the compressed air Ac taken in from the radially outer side Dro to the air intake port 72. The inventors analyzed the size of the foreign matter M included in the compressed air Ac in the accommodation chamber R. As a result, it was found that the size of the foreign matter M included in the compressed air Ac flowing from the radially outer side Dro toward the deflector 90 among the compressed air Ac flowing around the deflector 90 is larger than the size of the foreign matter M included in the compressed air Ac flowing from the axial upstream side Dau toward the deflector 90. Therefore, with the above-described configuration, the foreign matter M included in the compressed air Ac flowing from the radially outer side Dro is prevented from being taken into the air intake port 72, and the cooling air Ac is taken into the air intake port 72 from the axial upstream side Dau, and thus the foreign matter M is prevented from clogging the cooling structure of the stator vane 46a1.

In addition, as shown in FIGS. 6 and 7, the plate portion 92 is disposed to overlap at least a part of each of the two protruding portions 73 adjacent to each other in the circumferential direction Dc in a case of being viewed from the radially outer side Dro, with the gap G2 between the plate portion 92 and the two protruding portions 73 in the radial direction Dr. A part of the compressed air Ac flowing from the radially outer side Dro to the plate portion 92 collides with the main surface 92a of the plate portion 92 facing the radially outer side Dro, flows in the circumferential direction Dc, and then turns at an angle exceeding 90° (for example, approximately 180°) to flow into the air intake port 72 through the gap G2 in the radial direction Dr. In this process, the foreign matter M included in the compressed air Ac cannot turn due to the inertial force of the foreign matter M and is hardly taken into the air intake port 72. That is, while preventing the foreign matter M flying from the radially outer side Dro from being taken into the air intake port 72, a part of the compressed air Ac from which the foreign matter M is separated by the plate portion 92 can be taken into the air intake port 72 from the gap G2 between the plate portion 92 and the protruding portion 73. Therefore, for example, the amount of the compressed air Ac which is taken into the air intake port 72 and from which the foreign matter M is separated can be increased as compared with a case where the plate portion 92 abuts on the protruding portion 73 without leaving the gap G2 in the radial direction Dr.

### Second Embodiment

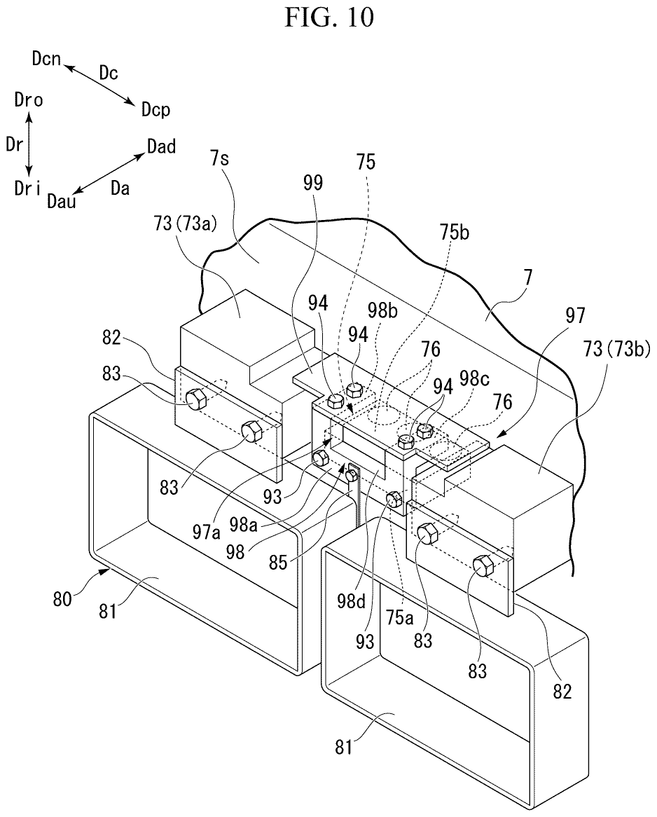

Hereinafter, a blade ring assembly according to a second embodiment of the present disclosure will be described with reference to FIGS. 10 to 12. In the following description, the same reference numerals are assigned to configurations having the same or similar functions as those of the first embodiment described above, and the description thereof will be omitted.

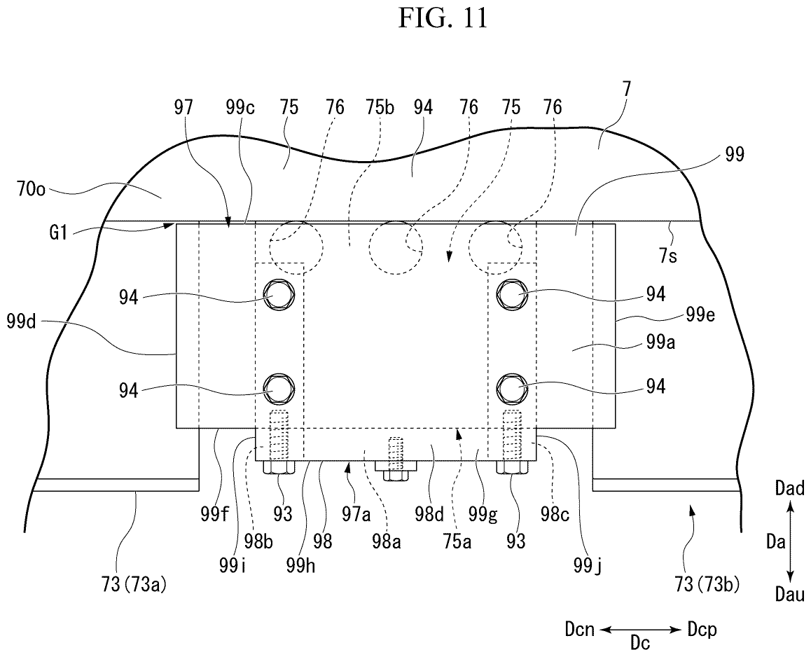

FIG. 10 is a perspective view showing a part of the blade ring assembly WS in an exploded manner, and FIG. 11 is a plan view of the deflector 97 when viewed from the radially outer side Dro. In the present embodiment, a cooling hole 76 formed in the radial direction Dr is formed in the deflector fixing portion 75. The cooling hole 76 penetrates the deflector fixing portion 75, one end of the cooling hole 76 on the radially outer side Dro is adjacent to the upstream surface 7s of the blade ring main body 7 and is open to the support surface 75b, and the other end of the cooling hole 76 on the radially inner side Dri is open to the first space S1 of the outer shroud 120. In the present embodiment, three cooling holes 76 are formed in one deflector fixing portion 75 to be spaced apart from each other in the circumferential direction Dc, but the number of cooling holes 76 is not limited to three and is appropriately selected according to the cooling performance required for the blade ring assembly WS.

The deflector 97 of the present embodiment includes a fixed base portion 98 and a plate portion 99. The fixed base portion 98 is attachably and detachably fixed to the deflector fixing portion 75 by the coupling tool 93, and includes a first portion 98a that abuts on the fixing surface 75a of the deflector fixing portion 75 from the axial upstream side Dau, and a pair of second portions 98b and 98c provided on the upper surface of the first portion 98a on the radially outer side Dro. The first portion 98a and the second portions 98b and 98c are a single component that is integrally molded. The second portions 98b and 98c are spaced apart from each other in the circumferential direction Dc, and do not inhibit the cooling medium from flowing between the second portions 98b and 98c. The fixed base portion 98 has an L-shape as viewed in the circumferential direction Dc, but unlike the fixed base portion 91 of the first embodiment described above, and the second portions 98b and 98c do not abut on the support surface 75b of the deflector fixing portion 75. Since the second portions 98b and 98c are provided on the upper surface of the first portion 98a on the radially outer side Dro, a groove 98d having the upper surface of the first portion 98a as a bottom is formed between one second portion 98b and the other second portion 98c. The groove 98d is formed in the axial direction Da and is continuous and flush with the support surface 75b of the deflector fixing portion 75. The groove 98d and the support surface 75b define an intake passage 97a of the cooling medium between the groove 98d and the support surface 75b, and the plate portion 99 fixed to the second portions 98b and 98c.

As shown in FIG. 11, the plate portion 99 has a plate shape that extends in a direction intersecting the radial direction Dr, and has two main surfaces 99a facing the radially outer side Dro and the radially inner side Dri. One main surface 99a facing the radially inner side Dri abuts on a surface of the second portions 98b and 98c of the fixed base portion 98 facing the radially outer side Dro. In each of the plate portions 99, two insertion holes through which the coupling tools 94 are passed are formed to be spaced apart from each other in the circumferential direction Dc. On the other hand, two coupling holes corresponding to each of the insertion holes of the plate portions 99 are formed on the surfaces of the second portions 98b and 98c facing the radially outer side Dro. The coupling tool 94 passed through the insertion hole of the plate portion 99 is coupled to the coupling holes of the second portions 98b and 98c, and thus the plate portion 99 is attachably and detachably fixed to the second portions 98b and 98c of the fixed base portion 98.

The plate portion 99 includes a first end portion 99c which is an end portion on the axial downstream side Dad, two second end portions 99d and 99e which are both end portions of the plate portion 99 in the length direction, a third end portion 99f which is an end portion on the axial upstream side Dau, and a rectangular hanging portion 99g which protrudes from the third end portion 99f to the axial upstream side Dau. The first end portion 99c is disposed with the gap G1 between the first end portion 99c and the upstream surface 7s of the blade ring main body 7 in a case of being viewed from the radially outer side Dro. The first end portion 99c and the third end portion 99f extend in the first direction as in the plate portion 92 of the first embodiment. Both of the second end portions 99d and 99e extend in the axial direction Da, and are parallel to each other. A leading edge 99h of the hanging portion 99g is parallel to the first end portion 99c, and the distance between two side edges 99i and 99j of the hanging portion 99g spaced apart from each other in the first direction is substantially equal to a length of the fixed base portion 98 in the circumferential direction Dc.

The second end portion 99d of the plate portion 99 protrudes in the circumferential direction Den, and the second end portion 99e protrudes in the circumferential direction Dcp. The plate portion 99 is disposed such that the second end portion 99d overlaps the first protruding portion 73a and the second end portion 99e overlaps the second protruding portion 73b, among the two protruding portions adjacent to each other in the circumferential direction Dc, in a case of being viewed from the radially outer side Dro. In addition, the second end portions 99d and 99e are disposed with a gap between the second end portions 99d and 99e and the protruding portions 73a and 73b in the radial direction Dr.

In the hanging portion 99g, in a case of being viewed from the radially outer side Dro, the leading edge 99h of the hanging portion 99g coincides with a surface of the first portion 98a of the fixed base portion 98 on the axial upstream side Dau, and two side edges 99i and 99j of the hanging portion 99g coincide with two side surfaces of the fixed base portion 98 spaced apart from each other in the circumferential direction Dc. As a result, since the hanging portion 99g is disposed to overlap the groove 98d of the fixed base portion 98, the groove 98d is shielded by the hanging portion 99g in a case of being viewed from the radially outer side Dro.

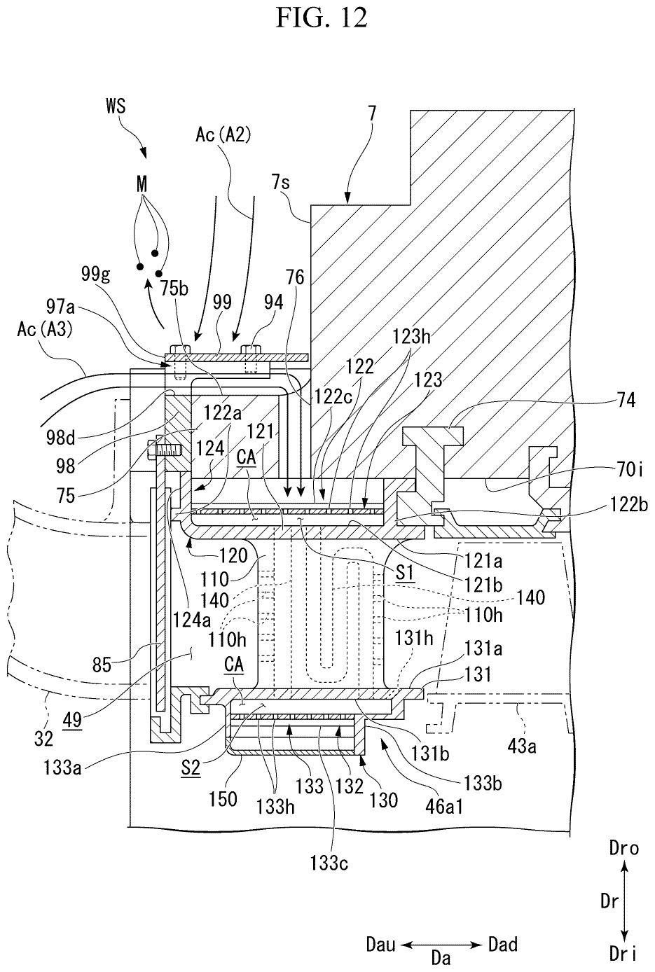

FIG. 12 is a cross-sectional view showing an action of the deflector 97. The compressed air Ac (A3) as the cooling medium, which flows from the axial upstream side Dau, with the angle of the flow direction changed by a guide portion (turning vane of the compressor), flows into the intake passage 97a of the deflector 97. The compressed air Ac which flows into the intake passage 97a flows to the axial downstream side Dad along the groove 98d and the support surface 75b between the second portions 98b and 98c, and collides with the upstream surface 7s of the blade ring main body 7. A part of the compressed air Ac that has collided with the upstream surface 7s changes the orientation toward the radially inner side Dri and flows into the first space S1 of the outer shroud 120 through the cooling hole 76. The cooling air Ac that has flowed into the inner peripheral side of the turbine blade ring 70 through the cooling hole 76 cools the blade body 110, the outer shroud 120, and the inner shroud 130, as in the first embodiment described above. In the present embodiment, since the cooling medium intake passage 97a is formed in the fixed base portion 98 of the deflector 97, the amount of the compressed air Ac flowing into the outer shroud 120 and the inner shroud 130 can be increased as compared with the deflector 90 of the first embodiment. As a result, the effect of the cooling structure of the stator vane 46al can be improved.

The compressed air Ac (A2) flowing along the rear wall 63 of the gas turbine casing 15 collides with the plate portion 99 of the deflector 97 instead of flowing into the air intake port 72, separately from the compressed air Ac (A3). In this case, the foreign matter M included in the compressed air Ac hits the plate portion 99 and bounces back, and flows to the axial upstream side Dau to be spaced apart from the air intake port 72. In the present embodiment, since the hanging portion 99g that protrudes to the axial upstream side Dau and that shields the groove 98d is formed on the plate portion 99 of the deflector 97, the foreign matter M hits the plate portion 99 and bounces back, and does not hit the groove 98d of the fixed base portion 98. That is, even in a case where the groove 98d forming a part of the intake passage 97a of the compressed air is formed in the fixed base portion 98 of the deflector 97, the hanging portion 99g can block the inflow of the foreign matter M from the intake passage 97a to the outer shroud 120 and the inner shroud 130. As a result, the foreign matter M is prevented from clogging the cooling structure of the stator vane 46a1.

### Other Embodiments

Hereinbefore, the embodiments of the present disclosure have been described in detail with reference to the drawings. However, the specific configuration is not limited to the configurations in the embodiments, and addition, omission, substitution, and other modifications can be made without departing from the gist of the present disclosure.

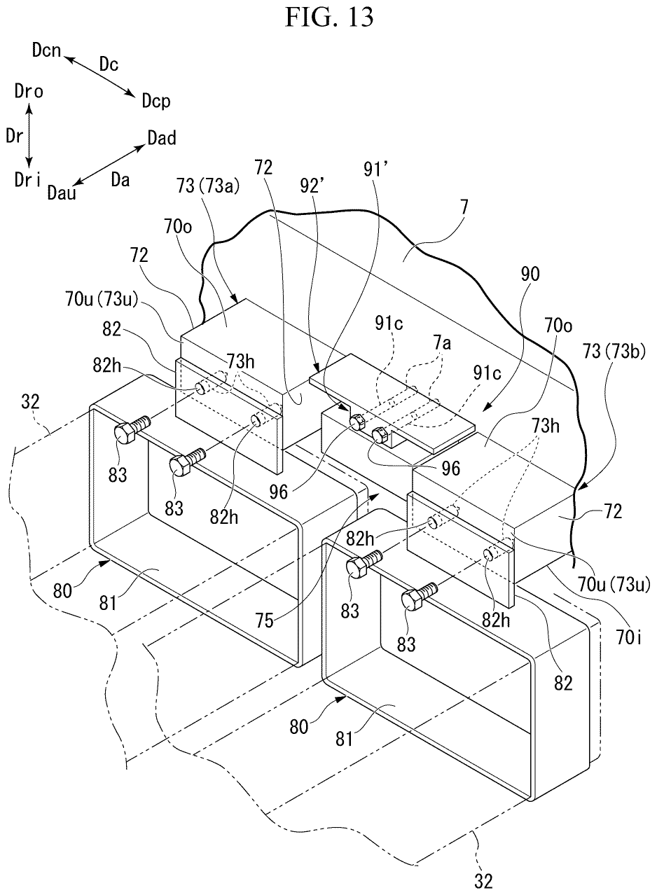

As shown in FIG. 13, a plate portion 92′ of the deflector 90 may be integrally formed with a fixed base portion 91′. In this case, an insertion hole 91c through which a coupling tool 96 such as a bolt is passed is formed in the fixed base portion 91′. A plurality of (for example, two) insertion holes 91c are formed in the fixed base portion 91′. The fixed base portion 91′ is fixed to the blade ring main body 7 by being coupled to a coupling hole 7a formed in the blade ring main body 7 in advance, in a state where the coupling tool 96 is passed through the insertion hole 91c. As a result, it is not necessary to separately attach each of the fixed base portion 91′ and the plate portion 92′, and thus, for example, work for attaching the deflector 90 to the turbine blade ring 70 is facilitated.

In addition, the plate portion 92 described in the above-described embodiment is not limited to the above-described disposition, and may be disposed, for example, in the air intake port 72.

### APPENDIX

The blade ring assembly and the gas turbine provided with the blade ring assembly according to the embodiment are understood as follows, for example.

(1) A blade ring assembly WS according to a first aspect including a turbine blade ring 70 that extending in a circumferential direction Dc about an axis Ar, a stator vane 46a is disposed on an inner peripheral side with respect to the turbine blade ring 70, and deflectors 90 and 97 are disposed on an outer peripheral side with respect to at least a part of the turbine blade ring 70, in which the turbine blade ring 70 includes a blade ring main body 7 and a plurality of protruding portions 73 that protruding from the blade ring main body 7 toward an axial upstream side Dau of both sides in an axial direction Da where the axis Ar extends and that is disposed at different positions in the circumferential direction De at intervals from each other, two protruding portions 73 included in the plurality of protruding portions 73 and adjacent to each other in the circumferential direction Dc, the two protruding portions form a cooling medium intake port (air intake port 72) which communicated from the outer peripheral side to the inner peripheral side of the turbine blade ring 70, together with the blade ring main body 7, and the deflectors 90 and 97 are disposed to shield at least a part of the cooling medium intake port in a case of being viewed in a radial direction Dr about the axis Ar.

As a result, most of the compressed air Ac flowing into the blade ring assembly WS from the outside in the radial direction Dr in the gas turbine casing 15 is not allowed to flow into the cooling medium intake port as it is, but collides with the deflectors 90 and 97 and bounces back. In this process, the foreign matter M (for example, rust or dust) included in the compressed air Ac flows to the axial upstream side Dau to be spaced apart from the cooling medium intake port. Therefore, the foreign matter M included in the compressed air Ac is unlikely to enter the cooling medium intake port from the outside in the radial direction Dr.

(2) A blade ring assembly WS according to a second aspect is the blade ring assembly WS according to the first aspect, in which the deflectors 90 and 97 may include plate portions 92, 92′, and 99 that have main surfaces 92a and 99a extending in a direction intersecting with the radial direction Dr.

As a result, the action of (1) can be realized with a simple configuration of the plate portions 92, 92′, and 99.

(3) A blade ring assembly WS according to a third aspect is the blade ring assembly WS according to the second aspect, in which the cooling medium intake port may have a minimum portion (narrow portion 72a) where the cooling medium intake port is narrowest between end portions of the two protruding portions 73 on the inner peripheral side, and a width L1 of the plate portions 92 and 92′ in a first direction where the two protruding portions 73 are adjacent to each other may be wider than a width L2 of the minimum portion of the cooling medium intake port in the first direction.

As a result, the compressed air Ac is unlikely to flow into the inner peripheral side of the turbine blade ring 70 through the cooling medium intake port from the outside in the radial direction Dr, as compared with a case where the width L1 of the plate portions 92 and 92′ is the same as or narrower than the width L2 of the first portion of the cooling medium intake port.

(4) A blade ring assembly WS according to a fourth aspect is the blade ring assembly WS according to the second or third aspect, in which the plate portions 92 and 92′ each may include a first end portion 92e1 which is an end portion on an axial downstream side Dad of both end portions of the plate portion 92 in the axial direction Da and a pair of second end portions 92e2 of the plate portion 92 which are both end portions in the first direction where the two protruding portions 73 are adjacent to each other, and the first end portion 92e1 and the pair of second end portions 92e2 may be disposed with gaps G1 and G2 with respect to the turbine blade ring 70.

As a result, since there are the gaps G1 and G2, even when tolerances occur in dimensions such as length, width, and thickness in the manufacturing process of the plate portions 92 and 92′, it is possible to prevent the interference of the plate portions 92 and 92′ with the turbine blade ring 70. As a result, for example, the number of man-hours required for the assembly of the blade ring assembly WS can be reduced.

(5) A blade ring assembly WS according to a fifth aspect is the blade ring assembly WS according to any one of the second to fourth aspects, in which the plate portions 92 and 92′ may include a third end portion 92e3 of the plate portion 92 which is an end portion on the axial upstream side Dau, and the third end portion 92e3 may be located on an axial downstream side Dad of both sides in the axial direction Da with respect to a surface (front surface 124a) of a retainer 124 included in the stator vane 46a, the surface facing the axial upstream side Dau.

As a result, the foreign matter M included in the compressed air Ac flowing from the axial upstream side Dau is unlikely to collide with the main surface 92a facing the inside of the plate portions 92 and 92′ in the radial direction Dr and bounce back, as compared with a case where the third end portion 92e3 is located at the same position in the axial direction Da as the surface of the retainer 124 facing the axial upstream side Dau or is located on the axial upstream side Dau with respect to the surface. In addition, the foreign matter M included in the compressed air Ac flowing from the outside in the radial direction Dr is unlikely to collide with the main surface 92a facing the inside of the plate portion 92 in the radial direction Dr and bounce back.

(6) A blade ring assembly WS according to a sixth aspect is any one of the blade ring assemblies according to the second to fifth aspects, in which the deflector 90 may further include the fixed base portions 91, 91′, and 98 disposed between the two protruding portions 73 in the circumferential direction Dc and attached to the turbine blade ring 70, and the plate portions 92, 92′, and 99 may be attached to outer end portions of the fixed base portions 91, 91′, and 98 in the radial direction Dr.

As a result, the fixed base portions 91 and 91′ in the cooling medium intake port can support the plate portions 92 and 92′ from the inside in the radial direction Dr.

(7) A blade ring assembly WS according to a seventh aspect is the blade ring assembly WS according to the sixth aspect, in which the plate portion 92 may include a third end portion 92e3 which is an end portion of the plate portion 92 on the axial upstream side Dau, and the third end portion 92e3 may be located on an axial downstream side Dad of both sides in the axial direction Da with respect to a surface of the fixed base portion 91 facing the axial upstream side Dau.

As a result, the foreign matter M included in the compressed air Ac flowing from the inside in the radial direction Dr with respect to the fixed base portion 91 is unlikely to collide with the main surface 92a facing the inside of the plate portion 92 in the radial direction Dr and bounce back, as compared with a case where the third end portion 92e3 is located at the same position in the axial direction Da as the surface of the fixed base portion 91 facing the axial upstream side Dau or is located on the axial upstream side Dau with respect to the surface.

(8) A blade ring assembly WS according to an eighth aspect is the blade ring assembly WS according to the sixth or seventh aspect, in which the fixed base portion 91 may be detachable from the turbine blade ring 70 in a state where the plate portion 92 and the fixed base portion 91 are integrated with each other.

As a result, for example, compared to a case where the fixed base portion 91 and the plate portion 92 are not integrated with each other, it is possible to easily perform maintenance such as repair on the fixed base portion 91 and the plate portion 92.

(9) A blade ring assembly WS according to a ninth aspect is the blade ring assembly WS according to any one of the sixth to eighth aspects, in which the fixed base portion 91 may include a fixing portion (first portion 91a including the coupling hole 91h) to which a sealing member 85 configured to seal a gap between two tail tubes 32 of a combustor 30 adjacent to each other in the circumferential direction De is fixable.

As a result, the fixed base portion 91 is a member that supports the plate portion 92 from the inside in the radial direction Dr and also serves as a member for fixing the sealing member 85. Therefore, for example, it is not necessary to provide a member other than the fixed base portion 91 in order to fix the sealing member 85.

(10) A blade ring assembly WS according to a tenth aspect is the blade ring assembly WS according to any one of the sixth to ninth aspects, in which the fixed base portion 98 may include a groove 98d that is formed in the axial direction Da on an inside in the radial direction with respect to the plate portion 99 and that defining a cooling medium intake passage 97a between the groove 98d and the plate portion 99.

As a result, since the inflow amount of the cooling medium into the cooling structure of the stator vane is increased, the cooling effect of the stator vane can be improved.

(11) A blade ring assembly WS according to an eleventh aspect is the blade ring assembly WS according to the tenth aspect, in which the plate portion 99 may include a hanging portion 99g is formed to protrude to the axial upstream side Dau and to overlap the groove 98d when viewed from an outside in the radial direction Dr.

As a result, even in a case where the deflector 97 in which the intake passage 97a of the compressed air is formed is adopted, the hanging portion 99g can block the foreign matter M from flowing into the cooling structure of the stator vane 46a1.

(12) A blade ring assembly WS according to the tenth aspect is the blade ring assembly WS according to any one of the first to eleventh aspects, in which each of the two protruding portions 73 may include a connecting portion (end surface 73u including the coupling hole 73h) configured to be connected to a fixing component (combustor connecting member 80) to which a tail tube 32 of a combustor 30 is fixed.

As a result, by using the two protruding portions 73, the lengths of the plate portions 92, 92′, and 99 can be made relatively long in the axial direction Da.

(13) A blade ring assembly WS according to the thirteenth aspect is the blade ring assembly WS according to any one of the first to twelfth aspects, in which the turbine blade ring 70 and the deflector 90 may be formed of a material having the same composition.

As a result, the influence of thermal expansion of the turbine blade ring 70 acting between the turbine blade ring 70 and the deflector 90 can be kept small. Therefore, it is possible to prevent the occurrence of the problem between the turbine blade ring 70 and the deflector 90.

(14) A blade ring assembly WS according to a fourteenth aspect is the blade ring assembly WS according to any one of the first to thirteenth aspects, in which the ratio at which the deflector 90 shields the cooling medium intake port in a case of being viewed from an outside in the radial direction Dr may be higher than the ratio at which the deflector 90 shields the cooling medium intake port in a case of being viewed from the axial upstream side Dau.

As a result, the amount of the cooling air Ac taken in from the axial upstream side Dau to the cooling medium intake port is larger than the amount of the compressed air Ac taken in from the outside in the radial direction Dr to the cooling medium intake port.

(15) A blade ring assembly WS according to a fifteenth aspect is the blade ring assembly WS according to any one of the first to fourteenth aspects, in which a fixing portion (first portion 91a including the insertion hole 93h) configured to fix the deflector 90 to the turbine blade ring 70 may be disposed between the two protruding portions 73 in the circumferential direction Dc.

As a result, for example, it is possible to achieve space savings as compared with a case where the fixing portion of the deflector 90 is disposed on the outer peripheral side or the inner peripheral side of the turbine blade ring 70.

(16) A blade ring assembly WS according to a sixteenth aspect is any one of the blade ring assemblies WS according to the first to fifteenth aspects, further including a forced cooling component (cooling medium circulation portion 100) is provided on the outer peripheral side of the turbine blade ring 70, and is disposed at a position overlapping the cooling medium intake port in a case of being viewed in the radial direction Dr, through which steam flows, in which the deflector 90 may be disposed on the inner peripheral side of the forced cooling component.

(17) A gas turbine 10 according to a seventeenth aspect including a rotor (gas turbine rotor 11) configured to rotate about the axis Ar, a casing (gas turbine casing 15) that covers the rotor from an outer peripheral side, the blade ring assembly WS according to any one of the first to sixteenth aspects configured to cover the rotor from the outer peripheral side in a state of being supported by the casing, and a combustor 30 configured to generate combustion gas G by combustion of fuel F and to send the combustion gas G into the casing, in which the stator vane 46a included in the blade ring assembly WS is a first stage turbine stator vane (stator vane 46a1) in the axial direction Da.

### REFERENCE SIGNS LIST

7 Blade ring main body
7a, 73h, 75h, 91h, 94h Coupling hole
7s Upstream surface
10 Gas turbine
11 Gas turbine rotor
15 Gas turbine casing
20 Compressor
21 Compressor rotor
22, 42 Rotor shaft
23, 43 Rotor blade stage
23a, 43a Rotor blade
25 Compressor casing
26, 46 Stator vane stage
26a Stator vane
30 Combustor
31 Intake portion
32 Tail tube
40 Turbine
41 Turbine rotor
45 Turbine casing
45a Outer casing
45b Inner casing
45c Ring segment
45p Cooling air passage
46a Gas turbine stator vane
46a1 Stator vane
49 Combustion gas flow path
50 Cooling device
51 Foreign matter collector
52 Cooler
53 Booster compressor
54 Cooling air line
61 Front wall
61a Tubular portion
61b Tubular lid portion
61h Opening
62 Peripheral wall
62a First peripheral wall
62b Second peripheral wall
63 Rear wall
64 Guide portion
70 Turbine blade ring
70o Outer peripheral surface
70i Inner peripheral surface
70d Downstream-side end surface
70u Upstream-side end surface
71 Blade ring fixing portion
72 Air intake port
72a Narrow portion
73 Protruding portion
73a First protruding portion
73b Second protruding portion
73u End surface
75 Deflector fixing portion
75a Fixing surface
75b Support surface
76 Cooling hole
80 Combustor connecting member
81 Frame portion
82 Flange
82h, 91c, 92h, 93h, 95h Insertion hole
83, 93, 94, 95, 96 Coupling tool
85 Sealing member
90, 97 Deflector
91, 91′, 98 Fixed base portion
91a First portion
91b Second portion
92, 92′, 99 Plate portion
92a, 99a Main surface
92e1 First end portion
92e2 Second end portion
92e3 Third end portion
98d Groove
99g Hanging portion
100 Cooling medium circulation portion
110 Blade body
110h Exhaust hole
120 Outer shroud
121, 131 Shroud main body
121a, 131a Ggas path surface
121b Outside inner surface
122, 132 Peripheral wall
122a, 132a Front wall portion
122b, 132b Rear wall portion
122c, 132c Rear-side wall portion
123, 133 Collision plate
123h Air hole
124 Retainer
124a Front surface
130 Inner shroud
131b Inside inner surface
140 Air passage
150 Shielding cover
A Air
A1, A2, A2′, A3, A4 Arrow
Ac Compressed air
Ar Axis
CA Cavity
Da Axial direction
Dad Axial downstream side
Dau Axial upstream side
Dc, Den, Dcp Circumferential direction
Dr Radial direction
Dri Radially inner side
Dro Radially outer side
F Fuel
G Combustion gas
G1, G2 Gap
GEN Generator
L1 Width of plate portion in first direction
L2 Width of narrow portion in first direction
R Accommodation chamber
S1 First space
S2 Second space
WS Blade ring assembly

1. A blade ring assembly comprising:
a turbine blade ring that extending in a circumferential direction about an axis;
a stator vane is disposed on an inner peripheral side with respect to the turbine blade ring; and
a deflector is disposed on an outer peripheral side with respect to at least a part of the turbine blade ring, wherein
the turbine blade ring includes
a blade ring main body, and
a plurality of protruding portions that protruding from the blade ring main body toward an axial upstream side of both sides in an axial direction where the axis extends, and that is disposed at different positions in the circumferential direction at intervals from each other,
two protruding portions included in the plurality of protruding portions and adjacent to each other in the circumferential direction,
the two protruding portions form a cooling medium intake port which communicated from the outer peripheral side to the inner peripheral side of the turbine blade ring, together with the blade ring main body, and
the deflector is disposed to shield at least a part of the cooling medium intake port in a case of being viewed in a radial direction about the axis.

2. The blade ring assembly according to claim 1, wherein the deflector includes a plate portion that has a main surface extending in a direction intersecting with the radial direction.

3. The blade ring assembly according to claim 2, wherein:
the cooling medium intake port has a minimum portion where the cooling medium intake port is narrowest between end portions of the two protruding portions on the inner peripheral side, and
a width of the plate portion in a first direction where the two protruding portions are adjacent to each other is wider than a width of the minimum portion of the cooling medium intake port in the first direction.

4. The blade ring assembly according to claim 2, wherein:
the plate portion includes a first end portion which is an end portion on an axial downstream side of both end portions of the plate portion in the axial direction and a pair of second end portions of the plate portion which are both end portions in the first direction where the two protruding portions are adjacent to each other, and
the first end portion and the pair of second end portions are disposed with a gap with respect to the turbine blade ring.

5. The blade ring assembly according to claim 2, wherein:
the plate portion includes a third end portion which is an end portion of the plate portion on the axial upstream side, and
the third end portion is located on an axial downstream side of both sides in the axial direction with respect to a surface of a retainer included in the stator vane, the surface facing the axial upstream side.

6. The blade ring assembly according to claim 2, wherein:
the deflector further includes a fixed base portion disposed between the two protruding portions in the circumferential direction and attached to the turbine blade ring, and
the plate portion is attached to an outer end portion of the fixed base portion in the radial direction.

7. The blade ring assembly according to claim 6, wherein:
the plate portion includes a third end portion which is an end portion of the plate portion on the axial upstream side, and
the third end portion is located on an axial downstream side of both sides in the axial direction with respect to a surface of the fixed base portion facing the axial upstream side.

8. The blade ring assembly according to claim 6, wherein the fixed base portion is detachable from the turbine blade ring in a state where the plate portion and the fixed base portion are integrated with each other.

9. The blade ring assembly according to claim 6, wherein the fixed base portion includes a fixing portion to which a sealing member configured to seal a gap between two tail tubes of a combustor adjacent to each other in the circumferential direction is fixable.

10. The blade ring assembly according to claim 6, wherein the fixed base portion includes a groove that is formed in the axial direction on an inside in the radial direction with respect to the plate portion and that defining a cooling medium intake passage between the groove and the plate portion.

11. The blade ring assembly according to claim 10, wherein the plate portion includes a hanging portion is formed to protrude to the axial upstream side and to overlap the groove when viewed from an outside in the radial direction.

12. The blade ring assembly according to claim 1, wherein each of the two protruding portions includes a connecting portion configured to be connected to a fixing component to which a tail tube of a combustor is fixed.

13. The blade ring assembly according to claim 1, wherein the turbine blade ring and the deflector are formed of a material having the same composition.

14. The blade ring assembly according to claim 1, wherein a ratio at which the deflector shields the cooling medium intake port in a case of being viewed from an outside in the radial direction is higher than a ratio at which the deflector shields the cooling medium intake port in a case of being viewed from the axial upstream side.

15. The blade ring assembly according to claim 1, wherein a fixing portion configured to fix the deflector to the turbine blade ring is disposed between the two protruding portions in the circumferential direction.

16. The blade ring assembly according to claim 1, further comprising:
a forced cooling component is provided on the outer peripheral side of the turbine blade ring and is disposed at a position overlapping the cooling medium intake port in a case of being viewed in the radial direction, through which a cooling medium flows, wherein
the deflector is disposed on the inner peripheral side of the forced cooling component.

17. A gas turbine comprising:
a rotor configured to rotate about the axis;
a casing that covers the rotor from an outer peripheral side;
the blade ring assembly according to claim 1 configured to cover the rotor from the outer peripheral side in a state of being supported by the casing; and
a combustor configured to generate combustion gas by combustion of fuel and send the combustion gas into the casing,
wherein the stator vane included in the blade ring assembly is a first stage turbine stator vane in the axial direction.
